(19) United States
(12) Patent Application Publication
(10) Pub. No.: US 2025/0357977 A1
(43) Pub. Date: Nov. 20, 2025

(54) ANTENNA DEVICE, ANTENNA DEVICE WITH MULTI-LAYER STRUCTURE AND WIRELESS COMMUNICATION DEVICE

(71) Applicant: Chiun Mai Communication Systems, Inc., New Taipei (TW)

(72) Inventors: PING-CHI KAO, New Taipei (TW); CHIA-MING LIANG, New Taipei (TW); LUNG-TA CHANG, New Taipei (TW); CHIA-HSIEN CHEN, New Taipei (TW); SHU-WEI JHANG, New Taipei (TW)

(21) Appl. No.: 19/207,595

(22) Filed: May 14, 2025

(30) Foreign Application Priority Data
May 14, 2024 (CN) 202410596954.7

(51) Int. Cl. H04B 7/0456; H01Q 3/36

(52) U.S. Cl. CPC H04B 7/0479; H01Q 3/36

(57) ABSTRACT

An antenna device is provided, including a plurality of radiators, a plurality of first feeding portions, a plurality of second feeding portions, a plurality of phase couplers, and a plurality of beamforming units; each of the first feeding portions is corresponded to each of the second feeding portions respectively; each phase coupler is correspondingly connected to each first feeding portion and each second feeding portion, each of the phase couplers is corresponded to each of the radiators; the beamforming units include a plurality of transmitting beamforming units and a plurality of receiving beamforming units; projection areas of each of first feeding portion and each second feeding portion on the corresponding radiator at least partially overlap; each phase coupler is respectively connected to one transmitting beamforming unit and one receiving beamforming unit.

### CROSS-REFERENCE TO RELATED APPLICATIONS

This application claims priority to Chinese Patent Application No. 202410596954.7 filed on May 14, 2024, in China National Intellectual Property Administration, the contents of which are incorporated by reference herein.

### FIELD

The subject matter herein generally relates to antenna technology field, and more particularly to an antenna device and an antenna device with multi-layer structure.

### BACKGROUND

In related technologies, analog phased array antennas often need to be provided with beamforming modules, such as beamforming integrated circuits (BFICs) to achieve beam synthesis of the phased array antennas and control beam angles. Since the BFICs are expensive, it is necessary to make full use of interfaces of the BFICs.

However, as shown in FIG. 13, when a plurality of circularly polarized antennas are used to form the phased array antenna, each existing transmitting antenna usually needs to occupy two RF output interfaces of a same Tx BFIC, and each receiving antenna usually needs to occupy two RF input interfaces of a same Rx BFIC. This undoubtedly increases a quantity of the BFICs used, thereby increasing the manufacturing cost.

### BRIEF DESCRIPTION OF THE DRAWINGS

Implementations of the present disclosure will now be described, by way of embodiments, with reference to the attached figures.

The patent or application file contains at least one drawing executed in color. Copies of this patent or patent application publication with color drawing(s) will be provided by the Office upon request and payment of the necessary fee.

FIG. 1 is a functional block diagram of an antenna device according to an embodiment of the present application.

FIG. 2 is a structural diagram of a phase coupler of FIG. 1.

FIG. 3A is a structural diagram of a second multiplexer of FIG. 1.

FIG. 3B is a cross-sectional structure diagram of the second multiplexer of FIG. 1.

FIG. 4 is a schematic diagram of a connection between a transmit beamforming unit, a receive beamforming unit, an LNA, the phase coupler, and a radiator according to an embodiment of the present application.

FIG. 5A is a schematic diagram of a current path on the phase coupler when the radiator is used as a receiving antenna according to an embodiment of the present application.

FIG. 5B is a schematic diagram of a current path on the phase coupler when the radiator is used as a transmitting antenna according to an embodiment of the present application.

FIG. 6 is a diagram showing a current intensity distribution on the phase coupler when the radiator is used as the receiving antenna according to one embodiment of the present application.

FIG. 7 is a schematic diagram of a phase difference between a first signal terminal and a second signal terminal measured by the phase coupler when the radiator transmits/receives a signal according to one embodiment of the present application.

FIG. 8 is a transmission coefficient curve diagram of the first signal terminal and the second signal terminal when the radiator receives the signal in the Ku band according to an embodiment of the present application.

FIG. 9 is a transmission coefficient curve diagram of the first signal terminal and the second signal terminal when the radiator transmits the signal in the Ku band according to an embodiment of the present application.

FIG. 10A is a current intensity distribution diagram on the phase coupler when the radiator is used as the receiving antenna and the energy of the first signal terminal and the second signal terminal flows to a receiving port according to an embodiment of the present application.

FIG. 10B is a current intensity distribution diagram on the phase coupler when the radiator is used as the transmitting antenna and the energy flows from a transmitting port to the first signal terminal and the second signal terminal according to an embodiment of the present application.

FIG. 11 is a schematic diagram of an isolation curve between the receiving port and the transmitting port of the phase coupler when the radiator shown in FIG. 1 receives/transmits the signal in the Ku band through the phase coupler.

FIG. 12 is a return loss curve of the receiving port, the transmitting port, the first signal terminal and the second signal terminal of the phase coupler measured when the radiator shown in FIG. 1 receives/transmits signals in the Ku band.

FIG. 13 is a schematic diagram of a circularly polarized antenna connected to a plurality of beamforming modules in the related art.

FIG. 14 is a schematic diagram showing eight combinations of the radiators and the phase couplers connected to the same transmitting beamforming unit and the same receiving beamforming unit according to one embodiment of the present application.

FIG. 15 is a schematic diagram showing that, in another embodiment of the present application, eight combinations of the phase couplers connected to the radiators through feeding portions are connected to the same transmitting beamforming unit and the same receiving beamforming unit.

FIG. 16 is a schematic diagram showing that, in another embodiment of the present application, the phase couplers are coupled to the radiators in a radiation area through the feeding portions to form eight combinations connected to the same transmitting beamforming unit and the same receiving beamforming unit.

FIG. 17 is a schematic diagram showing a comparison of an isolation curve between the transmitting port and the receiving port on the phase coupler when the radiator is directly connected to the phase coupler and the antenna device is not provided with the feeding portion and the coupling portion in an embodiment of the present application; and an isolation curve between the transmitting port and the receiving port on the phase coupler when the feeding portion and the coupling portion are provided in the antenna device and the phase coupler is connected to the radiator through the feeding portion and the coupling portion.

FIG. 18 is an overall top view schematic diagram of the antenna device provided in one embodiment of the present application.

FIG. 19 is a cross-sectional view of the antenna device with a multi-layer structure provided in one embodiment of the present application.

FIG. 20 is a cross-sectional view of the antenna device with a multi-layer structure provided in another embodiment of the present application.

FIG. 21 is a cross-sectional view of the antenna device with a multi-layer structure provided in another embodiment of the present application.

FIG. 22 is a cross-sectional view of the antenna device with a multi-layer structure provided in another embodiment of the present application.

FIG. 23 is a partial explored view of the antenna device when using the antenna device with the multi-layer structure as shown in FIG. 21.

FIG. 24 is a schematic diagram of a couple layer, a first feed layer, a second feed layer, a cavity layer, and a ground layer showing in FIG. 23.

FIG. 25 is a partial explored view of the antenna device when using the antenna device with the multi-layer structure as shown in FIG. 22.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or another word that “substantially” modifies, such that the component need not be exact. For example, “substantially cylindrical” means that the object resembles a cylinder, but can have one or more deviations from a true cylinder. The term “comprising” means “including, but not necessarily limited to”; it specifically indicates open-ended inclusion or membership in a so-described combination, group, series, and the like.

In related technologies, analog phased array antennas often need to be provided with beamforming modules, such as beamforming integrated circuits (BFICs) to achieve beam synthesis of the phased array antennas and control beam angles. Since the BFICs are expensive, it is necessary to make full use of interfaces of the BFICs.

However, as shown in FIG. 13, when a plurality of circularly polarized antennas are used to form the phased array antenna, each existing transmitting antenna usually needs to occupy two RF output interfaces of a same Tx BFIC, and each receiving antenna usually needs to occupy two RF input interfaces of a same Rx BFIC. This undoubtedly increases a quantity of the BFICs used, thereby increasing the manufacturing cost.

Based on this, it is necessary to provide an antenna device and an antenna device with multi-layer structure, which can fully utilize the interfaces on the BFIC, thereby reducing the quantity of configured BFICs and reducing manufacturing costs.

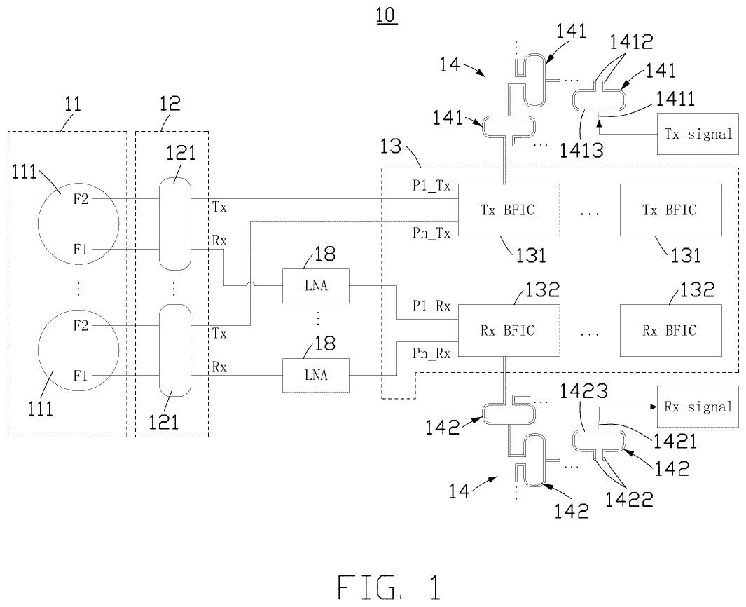

Referring to FIG. 1, FIG. 1 illustrates a functional block diagram of an array device 10. The array device 10 can be used to communicate with a low-orbit satellite (not shown in the figures). The antenna device 10 can be an independent signal transceiver, and the antenna device 10 can also be set on other equipment, such as a wireless communication device, to realize the wireless communication of the equipment based on the low-orbit satellite.

The array device 10 includes an array antenna 11, a phase coupler module 12, and a beamforming module 13. The array antenna 11 includes a plurality of radiators 111, and the phase coupler module 12 includes a plurality of phase couplers 121. Each of the plurality of phase couplers 121 is corresponded to each of the plurality of radiators 111. The beamforming module 13 includes a plurality of groups of signal terminals. The plurality of groups of signal terminals are connected and corresponded to the plurality of phase couplers 121, respectively. Each of the plurality of groups of signal terminals includes a radio frequency output interface (Pn_Tx, n is a positive integer, indicating the group number) and a radio frequency input interface (Pn_Rx). That is, each radiator 111 is connected to a corresponding group of signal terminals in the beamforming module 13 through a corresponding phase coupler 121.

Each radiator 111 can be used as a receiving antenna at a first time and as a transmitting antenna at a second time, that is, each radiator 111 can be used to receive and transmit wireless signals to achieve wireless communication based on low-orbit satellites. And each radiator 111 can be a circularly polarized antenna to reduce the impact of the ionosphere on satellite communications. It can be understood that the radiators 111 described herein can be circularly polarized antennas.

In some embodiments, the phase coupler 121 may be a hybrid coupler, each hybrid coupler 121 may be a 90° (90-degree) hybrid coupler, such as a quadrature hybrid divider. Each phase coupler 121 includes a transmitting port Tx, a receiving port Rx, a first signal terminal F1, and a second signal terminal F2. Radiation patterns of the transmitting port Tx and the receiving port Rx of the phase coupler 121 may be opposite circular polarization patterns. For example, the radiation pattern of the transmitting port Tx is a left-hand circular polarization radiation pattern and the radiation pattern of the receiving port Rx is a right-hand circular polarization radiation pattern. Another example, the radiation pattern of the transmitting port Tx is the right-hand circular polarization radiation pattern and the radiation pattern of the receiving port Rx is the left-hand circular polarization radiation pattern. Totally, the radiation pattern of the transmitting port Tx is opposite to the radiation pattern of the receiving port Rx. Specifically, the radiation patterns of the transmitting port Tx and the receiving port Rx are opposite circular polarization patterns.

The beamforming module 13 includes a plurality of beamforming units to form a beamforming module control system. The plurality of beamforming units are connected to the plurality of radiators 111 in the array antenna 11 through the plurality of phase couplers 121. In some embodiments, each beamforming unit may include at least one transmitting beamforming unit 131 and at least one receiving beamforming unit 132. In some embodiments, the beamforming unit may be, but is not limited to, a beamforming integrated circuit (BFIC), the transmitting beamforming unit 131 may be, but is not limited to, a transmitting beamforming integrated circuit (Transmitting BFIC, TxBFIC), and the receive beamforming unit 132 may be, but is not limited to, a receiving beamforming integrated circuit (Receiving BFIC, RxBFIC). The TxBFIC and RxBFIC shown in FIG. 1 are merely exemplarily represented as a transmitting beamforming unit 131 and a receiving beamforming unit 132, respectively.

In some embodiments, each transmitting beamforming unit 131 may be correspondingly connected to the plurality of radiators 111 through the plurality of phase couplers 121 of the phase coupler module 12 for generating beamforming signals, and transmitting radio beams with the specific pointing angles (or beamforming angles) through the plurality of radiators 111. Each receiving beamforming unit 132 may be correspondingly connected to the plurality of radiators 111 through the plurality of phase couplers 121 of the phase coupler module 12 for receiving radio beams with specific pointing angles (or beamforming angles) through the plurality of radiators 111, and generating beamforming signals. One transmitting beamforming unit 131 and one receiving beamforming unit 132 may be paired as a group of beamforming unit, and connected to the same plurality of radiators 111. Each beamforming unit can be or includes one group of one transmitting beamforming unit 131 and one receiving beamforming unit 132. As shown in the embodiment of FIG. 1, exemplary showing one transmitting beamforming unit 131 is connected to two radiators 111 through two phase couplers 121. When one transmitting beamforming unit 131 has more radio frequency output interfaces (Pn_Tx), then one transmitting beamforming unit 131 can be connected to more corresponding radiators 111 through more phase couplers 121. Similarly, FIG. 1 exemplary shows one receiving beamforming unit 132 is connected to two radiators 111 through two phase couplers 121. When one receiving beamforming unit 132 has more radio frequency input interfaces (Pn_Rx), then one receiving beamforming unit 132 can be connected to more corresponding radiators 111 through more phase couplers 121. It can be understood that one transmitting beamforming unit 131 has limited quantity of radio frequency output interfaces (Pn_Tx) and one receiving beamforming unit 132 has limited quantity of radio frequency input interfaces (Pn_Rx), through the abovementioned way of the application, the plurality of transmitting beamforming units 131 and the plurality of receiving beamforming units 132 are connected to the plurality of phase couplers 121, reducing the quantity of the radio frequency output interfaces (Pn_Tx) and the radio frequency input interfaces (Pn_Rx) used by each radiator 111.

In some embodiments, the array formed by the beamforming module 13 may be distributed as a plurality of beamforming unit areas, each beamforming unit area is formed by a predetermined quantity of beamforming units, and the quantity of beamforming units of each beamforming unit area may be the same. In some embodiments, the beamforming module 13 may be distributed as two groups, three groups, four groups, or more beamforming unit areas, which is not limited by the present application. In some embodiments, the plurality of beamforming unit areas formed by the beamforming module 13 may be determined by the arrangement positions of the connected plurality of radiators 111 in the antenna device 10, that is the plurality of radiators 111 in adjacent or neighboring arrangement is connected to the transmitting beamforming units 131 and the receiving beamforming units 132, and the plurality of transmitting beamforming units 131 and the plurality of receiving beamforming units 132 in adjacent or neighboring arrangement form a group of beamforming unit areas. In some embodiments, each beamforming unit area includes at least one transmitting beamforming units 131 and at least one receiving beamforming units 132. In some embodiments, the beamforming module 13 further includes a plurality of control units (not shown). The control unit is configured to process the electrical signals and data of the at least one transmitting beamforming units 131 and at least one receiving beamforming units 132 in the connected beamforming unit area. In some embodiments, each beamforming unit area includes same quantity of beamforming units, such as each beamforming unit area includes sixty-four beamforming units. In some embodiments, each beamforming unit area includes same quantity of the transmitting beamforming units 131 and the receiving beamforming units 132, such as each beamforming unit area includes sixty-four transmitting beamforming units 131 and sixty-four receiving beamforming units 132.

In some embodiments, the antenna device 10 further includes a plurality of low noise amplifiers (LNAs) 18. Each receiving beamforming unit 132 may be connected to the plurality of radiators 111 through the plurality of LNAs 18 and the plurality of phase couplers 121. The LNA 18 may be configured to obtain radio signals from the plurality of radiators 111, amplify the radio signals, and transmit the amplified radio signals to the receiving beamforming unit 132, the receiving beamforming unit 132 may obtain the radio signals from the radiator 111 through the LNA 18, analyze the radio signals, and generate the beamforming signal.

In FIG. 1, the plurality of phase couplers 121 is configured to transmit electrical signals between the plurality of groups of signal terminals and the plurality of radiators 111. When each radiator 111 serves as the transmitting antenna, the radiator 111 converts the electrical signal fed in by the corresponding phase coupler 121 into a wireless signal through radio waves and transmits the wireless signal. When each radiator 111 serves as the receiving antenna, the radiator 111 receives the radio wave through wireless transmitting medium (such as the air) and converts the radio wave into an electrical signal, and outputs the electrical signal through the corresponding phase coupler 121. Each phase coupler 121 includes a transmitting port Tx, a receiving port Rx, a first signal terminal F1, and a second signal terminal F2. In each phase coupler 121, the transmitting port Tx and the receiving port Rx are on one side of each phase coupler 121, the first signal terminal F1 and the second signal terminal F2 are on the other side of each phase coupler 121. Each phase coupler 121 is connected to one transmitting beamforming unit 131 and one receiving beamforming unit 132. In detail, each phase coupler 121 is connected to one radio frequency output interface Pn_Tx (n is a positive integer) of one transmitting beamforming unit 131 through one transmitting port Tx, and is connected to one radio frequency input interface Pn_Rx of one receiving beamforming unit 132 through one receiving port Rx. In addition, a same phase coupler 121 is connected to a same group of signal terminal. That is, each radiator 111 is connected to a same corresponding group of signal terminal through the corresponding phase coupler 121. Taking the two radiators 111 shown in FIG. 1 as example, one radiator 111 is connected to a first group of signal terminal (including one radio frequency output interface P1_Tx of one transmitting beamforming unit 131 and one radio frequency input interface P1_Rx of one receiving beamforming unit 132) through one corresponding phase coupler 121. The other radiator 111 is connected to a n^{th} group of signal terminal (including one radio frequency output interface Pn_Tx of one transmitting beamforming unit 131 and one radio frequency input interface Pn_Rx of one receiving beamforming unit 132) through the other corresponding phase coupler 121. In detail, the transmitting port Tx of one of the phase couplers 121 is connected to one radio frequency output interface P1_Tx of one transmitting beamforming unit 131. The receiving port Rx of one of the phase couplers 121 is connected to one radio frequency input interface P1_Rx of one receiving beamforming unit 132 through the LNA 18. The first signal terminal F1 and the second signal terminal F2 of one of the phase couplers 121 are respectively connected to two feed points (not shown in the figures) of one of the radiators 111. The transmitting port Tx of the other phase coupler 121 is connected to one radio frequency output interface Pn_Tx of one transmitting beamforming unit 131. The receiving port Rx of the other phase coupler 121 is connected to one radio frequency input interface Pn_Rx of one receiving beamforming unit 132 through the LNA 18. The first signal terminal F1 and the second signal terminal F2 of the other phase coupler 121 are respectively connected to two feed points (not shown in the figures) of the other radiator 111.

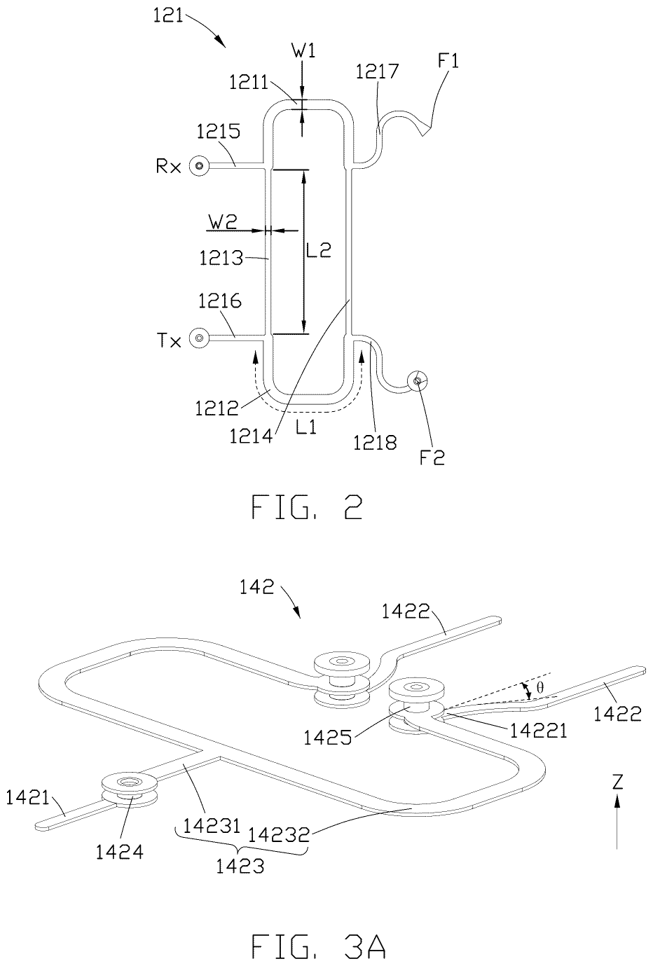

Referring to FIGS. 1 and 2, in one embodiment, the phase couplers 121 can be made of conductive materials, such as metal etc. As shown in FIG. 2, the phase coupler 121 includes a first bent section 1211, a second bent section 1212, a first vertical section 1213, a second vertical section 1214, a first connecting section 1215, a second connecting section 1216, a third connecting section 1217, and a fourth connecting section 1218. The first bent section 1211 is substantially inverted U-shaped, the second bent section 1212 is substantially U-shaped. Two ends of the first vertical section 1213 are respectively connected to a first end of the first bent section 1211 and a first end of the second bent section 1212. Two ends of the second vertical section 1214 are respectively connected to a second end of the first bent section 1211 and a second end of the second bent section 1212. Thus, the first bent section 1211, the second bent section 1212, the first vertical section 1213, and the second vertical section 1214 are connected to form a substantial oval. A first end of the first connecting section 1215 is connected to an end of the first bent section 1211, a second end of the first connecting section 1215 is extended for a certain distance away from the first vertical section 1213, the first connecting section 1215 is substantially perpendicularly connected to the first vertical section 1213. The second end of the first connecting section 1215 serves as the receiving port Rx of the phase coupler 121. A first end of the second connecting section 1216 is connected to the first end of the second bent section 1212, a second end of the second connecting section 1216 is extended for a certain distance away from the first vertical section 1213, the second connecting section 1216 is substantially perpendicularly connected to the first vertical section 1213. The second end of the second connecting section 1216 serves as the transmitting port Tx of the phase coupler 121. The third connecting section 1217 and the fourth connecting section 1218 are both substantially in bent shaped. A first end of the third connecting section 1217 is connected to the second end of the second bent section 1212, a second end of the third connecting section 1217 is extended in an inverted U-shaped away from the second vertical section 1214. The second end of the third connecting section 1217 serves as the first signal terminal F1 of the phase coupler 121. A first end of the fourth connecting section 1218 is connected to the second end of the second bent section 1212, a second end of the fourth connecting section 1218 is extended in an inverted U-shaped away from the second vertical section 1214. The second end of the fourth connecting section 1218 serves as the second signal terminal F2 of the phase coupler 121.

In some embodiments, a length L1 of each of the first bent section 1211 and the second bent section 1212 is substantially λ/4. A length L2 of each of the first vertical section 1213 and the second vertical section 1214 is substantially λ/4. A frequency reference point of the wavelength may be 12 GHz. In other embodiments, other frequency points in the Ku band may also be selected as the frequency reference point of the wavelength. A width of each of the first bent section 1211, the second bent section 1212, the first vertical section 1213, and the second vertical section 1214 is related to the impedance of the phase coupler 121. Specifically, the less the impedance of the phase coupler 121, the greater the width of each of the first bent section 1211, the second bent section 1212, the first vertical section 1213, and the second vertical section 1214. In one embodiment, an impedance of each of the first vertical section 1213, the second vertical section 1214, the first connecting section 1215, the second connecting section 1216, the third connecting section 1217, and the fourth connecting section 1218 is Z0; an impedance of each of the first bent section 1211 the second bent section 1212 is Z0/\sqrt{2}, Z0 is the overall impedance of the phase coupler 121. In one embodiment, in order to make the overall impedance Z0 of the phase coupler 121 reach 50 ohms, the widths W1 of the first bent section 1211 and the second bent section 1212 are adjusted so that the impedances of the first bent section 1211 and the second bent section 1212 are both approximately Z0/\sqrt{2}, that is, 35.36 ohms. The widths W2 of the first vertical section 1213 and the second vertical section 1214 is adjusted so that the impedance of the first vertical section 1213 and the second vertical section 1214 is approximately Z0, that is, 50 ohms. Since of impedance Z0/\sqrt{2} of the first bent section 1211 and the second bent section 1212 is less than the impedance Z0 of the first vertical section 1213 and the second vertical section 1214, thus the width W1 of first bent section 1211 and the second bent section 1212 is greater than the width W2 of the first vertical section 1213 and the second vertical section 1214. The present application does not specifically limit the impedance and length of the first bent section 1211, the second bent section 1212, the first vertical section 1213, and the second vertical section 1214. In other embodiments, the impedance and length of the first bent section 1211, the second bent section 1212, the first vertical section 1213, and the second vertical section 1214 can be adjusted according to actual needs, as long as the phase coupler 121 can achieve impedance matching.

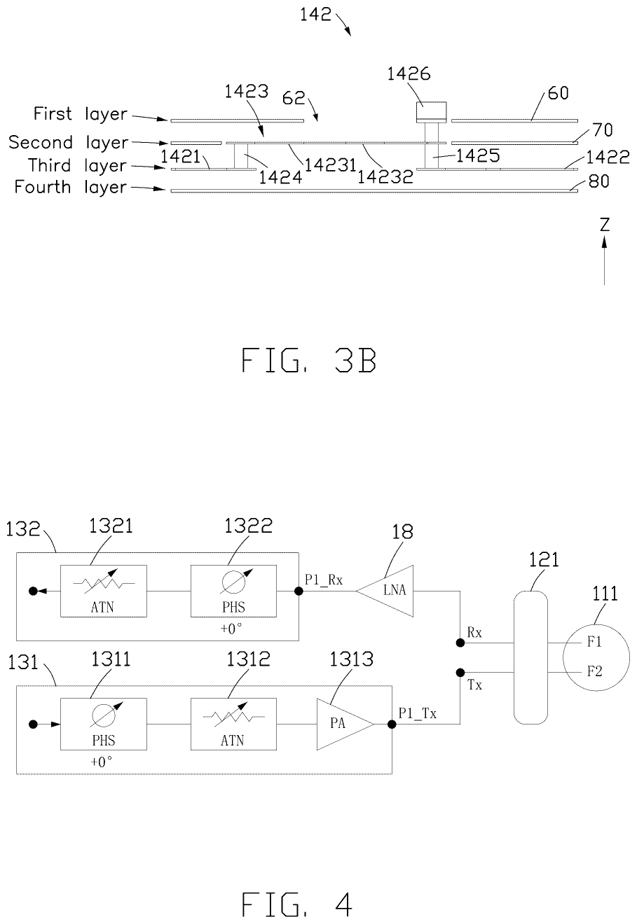

Referring to FIGS. 1, 3A, 3B, in some embodiments, the antenna device 10 may include a plurality of planes and a plurality of multiplexers 14 arranged in the plurality of planes. Specifically, the antenna device 10 includes at least one multiplexer 14 arranged in different planes. The plurality of multiplexers 14 are connected to the beamforming module 13. The plurality of multiplexers 14 are configured to connect the plurality of transmitting beamforming units 131 and the plurality of receiving beamforming units 132 in parallel. That is, the plurality of multiplexers 14 are configured to conduct electric signals for the beamforming module 13, to connect each transmitting beamforming unit 131 in the beamforming module 13 in parallel to a same transmitting signal output point, and to connect each receiving beamforming unit 132 in the beamforming module 13 in parallel to a same receiving signal input point, to realize an effect of signal power superposition after beamforming. In detail, the plurality of multiplexers 14 include a plurality of first multiplexers 141 and a plurality of second multiplexers 142. In some embodiments, the plurality of first multiplexers 141 are connected among the transmitting signal output point and the plurality of transmitting beamforming units 131. In some embodiments, the plurality of second multiplexers 142 are connected among the receiving signal output point and the plurality of receiving beamforming units 132. More specifically, the plurality of first multiplexers 141 are connected among the transmitting signal output point and the plurality of transmitting beamforming units 131, to conduct the one transmitting signal (Tx signal) output by the transmitting signal output point into a plurality of transmitting signals with a same transmitting power, and further output to each transmitting beamforming unit 131, the plurality of transmitting beamforming units 131 are connected in parallel. More specifically, the plurality of second multiplexers 142 are connected among the receiving signal output point and the plurality of receiving beamforming units 132, to conduct a plurality of beamforming signals received by the plurality of second multiplexers 142 into on receiving signal (Rx signal), and further output through the receiving signal output point, the plurality of receiving beamforming units 132 are connected in parallel.

The plurality of multiplexers 14 can be arranged in different planes of the antenna device 10, that is the plurality of multiplexers 14 (such as the plurality of first multiplexers 141 and the plurality of second multiplexers 142) can be arranged in different planes of the antenna device 10, so as to decrease an area of the antenna device 10. The plurality of multiplexers 14 arranged in different planes can be connected through vias (not shown). In some embodiments, one of the first multiplexers 141 and the second multiplexers 142 may be arranged in different planes (such as different layers of the circuit board) of the antenna device 10, the other one of the first multiplexers 141 and the second multiplexers 142 may be arranged in a same plane, so as to avoid the first multiplexers 141 and the second multiplexers 142 from being in the same plane, and thus avoiding over area of the antenna device 10. In one specific embodiment, each of the first multiplexers 141 is arranged in the same plane, each of the second multiplexers 142 is arranged in different planes. In another specific embodiment, each of the first multiplexers 141 is arranged in different planes, each of the second multiplexers 142 is arranged in the same plane. In one specific embodiment, each of the first multiplexers 141 can be a one-layer multiplexer, each of the second multiplexers 142 can be a multi-layer multiplexer. In another specific embodiment, each of the first multiplexers 141 can be a multi-layer multiplexer, each of the second multiplexers 142 can be a one-layer multiplexer.

In one specific embodiment of the present application, each of the plurality of second multiplexers 142 is a multi-layer multiplexer, and each multi-layer multiplexer is arranged in different planes. Specifically, referring to FIGS. 3A and 3B, in some embodiments, the second multiplexer 142 includes a first end 1421, at least two second ends 1422, a connecting portion 1423, a first conductive portion 1424, and at least two second conductive portions 1425. In other embodiments, the plurality of first multiplexers 141 can be a multi-layer multiplexer; for example, the plurality of first multiplexer 141 are multi-layer multiplexers, while the plurality of second multiplexers 142 are one-layer multiplexers; or, for example, both of the plurality of first multiplexers 141 and the plurality of second multiplexers 142 include multi-layer multiplexers. The present application takes the plurality of second multiplexers 142 being multi-layer multiplexers as an example for further description, not limited here.

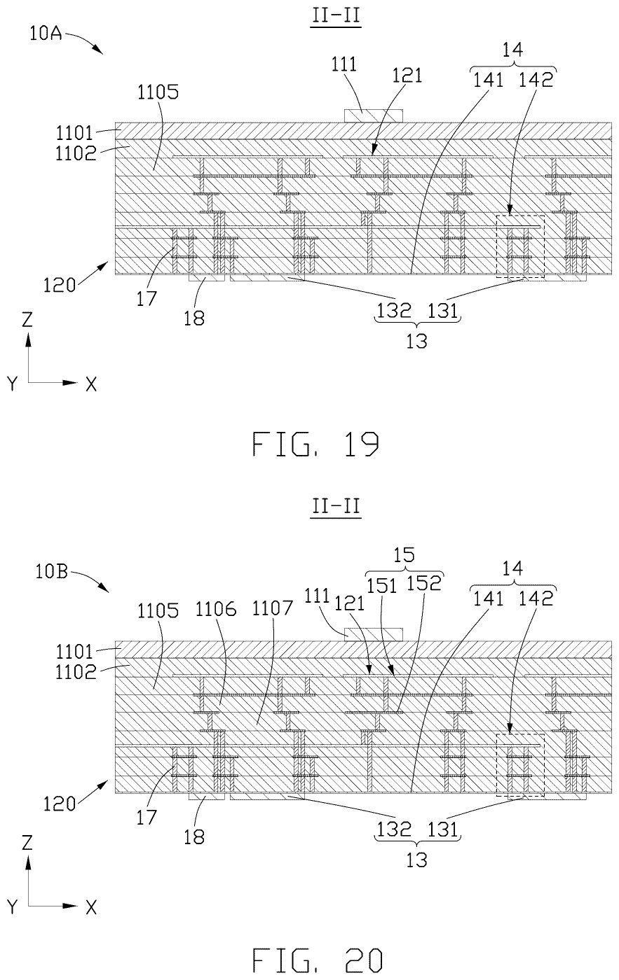

In some embodiments, referring to FIGS. 3A and 3B, the first end 1421 and the at least two second ends 1422 of the second multiplexer 142 are both substantially linear metal segment structures and are substantially parallel or non-parallel to each other. The first end 1421 and the at least two second ends 1422 are coplanar and arranged on a same layer of the circuit board (not shown in FIG. 3A, for example, from a first layer to a fourth layer as shown in FIG. 3B; for example, the multi-layer circuit board 120 as shown in FIGS. 19 to 22). In some embodiments, the at least two second ends 1422 of the second multiplexer 142 may be symmetrical or asymmetrical structures, for example, the at least two second ends 1422 may be symmetrically or asymmetrically arranged with respect to the first end 1421. It can be understood that when the at least two second ends 1422 are arranged in parallel or symmetrically, the at least two second ends 1422 may be made to have substantially the same signal conduction path, and have a better signal conduction effect.

The connecting portion 1423 is connected between the first end 1421 and the at least two second ends 1422, the first end 1421 and the at least two second ends 1422 are arranged on opposite ends of the connecting portion 1423. The connecting portion 1423 may include a first connecting section 14231 and a second connecting section 14232. In some embodiments, the first connecting section 14231 is substantially a straight metal section, and the second connecting section 14232 is substantially a rectangular ring-shaped metal section structure. One end of the first connecting section 14231 is connected to the first end 1421, and the other end of the first connecting section 14231 is connected to a substantially middle position of a long side of the second connecting section 14232. The other long side of the second connecting section 14232 can be connected to the at least two second ends 1422 respectively. In some embodiments, the connecting portion 1423 is not coplanar with the first end 1421 and the at least two second ends 1422, and can be arranged on different layers of the circuit board (not shown in FIG. 3A, for example, from the first layer to the fourth layer as shown in FIG. 3B; for example, the multi-layer circuit board 120 as shown in FIGS. 19 to 22). For example, the connecting portion 1423 can be arranged on a second layer of the circuit board. In some embodiments, the connecting portion 1423 is arranged on the second layer of the circuit board, which is convenient to arrange wiring with other second multiplexers 142. In some embodiments, the second connecting section 14232 may also be in other symmetrical regular shapes, such as a circle, an ellipse, a rectangle, etc., and the second connecting section 14232 is symmetrical with respect to the first connecting section 14231.

In some embodiments, each of the first end 1421 and the at least two second ends 1422 have a first resistance value, and the connecting portion 1423 has a second resistance value, wherein the first resistance value may be less than or equal to the second resistance value. The first resistance value may be, but is not limited to, 50 ohms (Ω), and the second resistance value may be, but is not limited to, 70.7 ohms. In some embodiments, a signal conduction path of the first end 1421 is divided into two signal conduction paths of the at least two second ends 1422, in order to make the energy equal, the connecting portion 1423 connecting the first end 1421 and the at least two second ends 1422 meets a formula Z=\sqrt{2}*Z₀, wherein Z₀ is the first resistance value of the first end 1421 and the at least two second ends 1422, that is Z₀=50 ohms, Z is the second resistance value of the connecting portion 1423, calculation shows that Z=70.7 ohms. Since the first end 1421 and the at least two second ends 1422 are respectively set with the same preset resistance value, and the connecting portion 1423 is set with a different preset resistance value, the energy conducted by the first end 1421, the connecting portion 1423, and the at least two second ends 1422 is substantially equal, thereby reducing the loss of energy conduction. The first connecting section 14231 can be used to convert the first resistance value of the first end 1421 to the second resistance value of the connecting portion 1423 during energy conduction, or to convert the second resistance value of the connecting portion 1423 to the first resistance value of the first end 1421. In some embodiments, to match the configuration of the circuit board, the connecting portion 1423, the first end 1421, and the at least two second ends 1422 may have different line widths, so that the connecting portion 1423, the first end 1421, and the at least two second ends 1422 may have substantially equal signal conduction powers.

The first conductive portion 1424 is connected between the first end 1421 and the connecting portion 1423, and the first conductive portion 1424 connects the layer or plane where the first end 1421 is located and the layer or plane where the connecting portion 1423 is located, that is, the first conductive portion 1424 connects the second layer and the third layer of the circuit board. In some embodiments, the first conductive portion 1424 may be, but is not limited to, a metal column, one end of the metal column is connected to the first end 1421, and the other end of the metal column is connected to the first connecting section 14231.

The at least two second conductive portions 1425 are connected between the at least two second ends 1422 and the connecting portion 1423, and the second conductive portions 1425 connect the layer or plane where the at least two second ends 1422 are located and the layer or plane where the connecting portion 1423 is located, that is, the second conductive portions 1425 connect the second layer and the third layer of the circuit board. In some embodiments, the second conductive portions 1425 may be, but are not limited to, two metal pillars, one end of the two metal pillars is respectively connected to the at least two second ends 1422, and the other end of the two metal pillars is connected to a side of the second connecting section 14232 away from the first connecting section 14231. In some embodiments, an extension line of the first connecting section 14231 is substantially perpendicular to a connection line of the two second conductive portions 1425 (i.e., the two metal pillars).

In some embodiments, each of the at least two second ends 1422 includes a connection point 14221. The connection points 14221 of the at least two second ends 1422 are connected to the second conductive portions 1425, respectively. The second end 1422 is formed by the connection point 14221 extending outward from the second conductive portion 1425. A direction in which the second end 1422 extends outward from the connection point 14221 and a direction perpendicular to the second connecting section 14232 form an angle θ. In some embodiments, the angle θ may range from, but is not limited to, 0 degrees to 90 degrees.

Referring to FIGS. 3A and 3B again, in some embodiments, the signal conduction direction of the first end 1421 is substantially the same as the signal conduction direction of the at least two second ends 1422. In some embodiments, a vector difference between the signal conduction direction of the first end 1421 and the signal conduction direction of the at least two second ends 1422 may be 0 degrees to 90 degrees. For instance, the signal conduction direction of the first end 1421 is toward the first conductive portion 1424, the first conductive portion 1424 conducts the signal to the first connecting section 14231, and the signal conduction direction of the first connecting section 14231 is from the first conductive portion 1424 toward the second connecting section 14232, but the signal conduction direction of the first end 1421 is consistent with the signal conduction direction of the first connecting section 14231. The signal conduction direction of the first end 1421 and the first connecting section 14231 can be defined as a first vector. The second connecting section 14232 obtains the signal from the first connecting section 14231 and conducts the signal to the two second conductive portions 1425. The at least two second ends 1422 are respectively connected to the two second conductive portions 1425 through the connecting points 422 and serve as endpoints of the signal conduction of the at least two second ends 1422. The structure along the at least two second ends 1422 serves as the signal conduction paths of the at least two second ends 1422. The signal conduction direction of the at least two second ends 1422 can be defined as a second vector. A vector difference between the first vector and the second vector can be 0 degrees to 90 degrees.

Please refer to FIGS. 1, 3A and 3B, in some embodiments, each multiplexer 14 may further include a resistor (not shown in FIGS. 1 and 3A, for example, resistor 1426 as shown in FIG. 3B). Each multiplexer 14 may be further arranged in different planes of the antenna device 10 formed by different substrates. Taking the second multiplexer 142 of FIGS. 3A and 3B for example, the second multiplexer 142 may further include a resistor 1426. The resistor 1426 may be in contact with the second connecting portion 14232 through the second conductive portion 1425. In some embodiments, the second multiplexer 142 may be arranged in different planes (such the first layer to the fourth layer as shown in FIG. 3B) of the antenna device 10. The resistor 1426 is not on the same plane as the first end 1421, the at least two second ends 1422, and the connecting portion 1423, that is, the resistor 1426 is on a plane different from that of the first end 1421, the at least two second ends 1422, and the connecting portion 1423. The resistor 1426 can be arranged on the first layer. In some embodiments, the second conductive portion 1425 can be respectively connected to the resistor 1426, the second connecting section 14232 of the connecting portion 1423, and the at least two second ends 1422, that is, the second conductive portion 1425 can connect the first layer, the second layer, and the third layer as shown in FIG. 3B.

In some embodiments, the first layer where the resistor 1426 is located may be a surface layer of the antenna device 10, the fourth layer is an internal layer of the antenna device 10. In the embodiment, a quantity of the layers can be adjusted according to actual needs, the layers shown in FIG. 3B is exemplary.

In some embodiments, as shown in FIG. 3B, the antenna device 10 may further include a first ground layer 60, a second ground layer 70, and a third ground layer 80.

The first ground layer 60 may be arranged on the first layer and arranged adjacent to the resistor 1426. The second ground layer 70 may be arranged on the second layer and arranged adjacent to the connecting portion 1423. The third ground layer 80 may be arranged on a fourth layer. The third ground layer 80 may be located between the layer where the array antenna 11 (shown in FIG. 1) is located and the layer where the first end 1421 and the at least two second ends 1422 are located. The first ground layer 60, the second ground layer 70, and the third ground layer 80 may be used to provide grounding for the array device 10. The second ground layer 70 and the third ground layer 80 may be used as reference grounds for the first end 1421 and the at least two second ends 1422, and the third ground layer 80 may be used as a reference ground for the connecting portion 1423. In some embodiments, the first ground layer 60 is provided with an opening 62, and the opening 62 is arranged corresponding to the connecting portion 1423, so that the connecting portion 1423 can have a larger wiring width, thereby reducing the energy conduction loss of the connecting portion 1423 when conducting signals.

In some embodiments, a first through hole is formed through the second layer to the third layer. The second through hole is filled with a metal conductor to form the first conductive portion 1424. The first conductive portion 1424 penetrates the second layer to the third layer to respectively connect the connecting portion 1423 on the second layer and the first end 1421 on the third layer, to achieve electrical connection and signal conduction between the connecting portion 1423 and the first end 1421. Second through holes are formed through the first layer to the third layer. The second through hole are filled with metal conductors to form the two second conductive portions 1425. The second conductive portions 1425 penetrate the first layer to the third layer to respectively connect the resistor 1426 located on the first layer, the connecting portion 1423 located on the second layer, and the at least two second ends 1422 located on the third layer, so as to realize electrical connection and signal conduction among the resistor 1426, the connecting portion 1423, and the at least two second ends 1422. It can be understood that the first to fourth layers can be spaced apart from each other and arranged in parallel.

In some embodiments, when the first end 1421 and the at least two second ends 1422 of the second multiplexer 142 are arranged on a same plane (that is the third layer), the connecting portion 1413 is arranged on another same plane (that is the second layer), by obtaining a S-parameters of the second multiplexer 142 at this time, an overall maximum loss of the second multiplexer 142 is approximately 3.41 decibels (dB). When the first end 1421, the at least two second ends 1422, and the connecting portion 1413 of the second multiplexer 142 are arranged on a same plane (that is the third layer), by obtaining a S-parameters of the second multiplexer 142 at this time, an overall maximum loss of the second multiplexer 142 is approximately 4.91 decibels (dB). It can be seen that the loss is relatively greater in the inner layer, and compared with the two arrangements of the second multiplexer 142, the first end 1421 and the at least two second ends 1422 of the second multiplexer 142 in the embodiment of the present application and the connecting portion 1423 are arranged on different planes (especially the connecting portion 1423 is arranged at the outer layer of the antenna device 10). Compared with the first end 1421, at least two second ends 1422, and the connecting portion 1423 of the second multiplexer 142 being arranged on the same plane, the signal conduction loss of the second multiplexer 142 in the embodiment of the present application is lower, which is more conducive to the second multiplexer 142 being used for signal conduction of the antenna device 10.

The structures of the first multiplexer 141 mentioned in FIG. 1 and the second multiplexer 142 are substantially the same. The first multiplexer 141 includes a first end 1411, at least two second ends 1412, and a connecting portion 1413, the difference is that the first end 1411, the at least two second ends 1412, and the connecting portion 1413 of the first multiplexer 141 can be arranged on the same plane. That is, in some embodiments, each of the plurality of first multiplexers 141 is a one-layer multiplexer, and each one-layer multiplexer is distributed on the same plane. Thus, the first end 1411 of the first multiplexer 141 can be directly connected to the two second ends 1412 through the connecting portion 1413, without the need to provide the first conductive portion and the second conductive portion. In some embodiments, the first end 1411, at least two second ends 1412, and the connecting portion 1413 of the first multiplexer 141 may be disposed on the same plane of the surface layer of the antenna device 10. The structure of the first multiplexer 141 is not further described herein.

Please refer to FIG. 1 and FIG. 3B together, in the embodiment of the present application, a plurality of second multiplexers 142 form a cascade circuit structure. Specifically, taking the cascade circuit structure shown in FIG. 1 as an example, the level where the plurality of second multiplexers 142 connected to the receiving beamforming unit 132 are located is taken as the first level, and the plurality of second multiplexers 142 are arranged in the first level circuit, and the second ends 1422 of each second multiplexer 142 is connected to the corresponding receiving beamforming unit 132, so as to collect the multi-path beamforming signals received by each receiving beamforming unit 132 to the next level. Thus, the quantity of the second multiplexers 142 in the first level circuit is half the quantity of the connected receiving beamforming units 132. Similarly, in the last level circuit of the cascade circuit formed by the plurality of second multiplexers 142, only one second multiplexer 142 is provided, and the first end 1421 of the second multiplexer 142 is connected to the receiving signal input point to aggregate the multiple beamforming signals into one receiving signal (Rx signal). In this case, the second multiplexers 142 may be power combiners.

Please refer to FIG. 1 again. In the embodiment of the present application, a plurality of first multiplexers 141 also form a cascade circuit structure. Specifically, taking the cascade circuit structure shown in FIG. 1 as an example, the level where the first multiplexer 141 connected to the transmitting signal input point for receiving the transmitting signal (Tx signal) is located is the first level, then only one first multiplexer 141 is set in the first level circuit, and the first end 1411 of the first multiplexer 141 is connected to the transmitting signal output point to receive the transmitting signal (Tx signal), and the two second ends 1412 of the first multiplexer 141 are respectively connected to the first ends 1411 of the other two first multiplexers 141 in the second level circuit. Similarly, the two second ends 1412 of each first multiplexer 141 in the last level circuit are respectively connected to the corresponding transmitting beamforming unit 131. That is, the quantity of first multiplexers 141 in the last level circuit is half the quantity of transmitting beamforming units 131 connected to the last level circuit. In this case, the first multiplexers 141 can be power dividers, such as Wilkinson dividers.

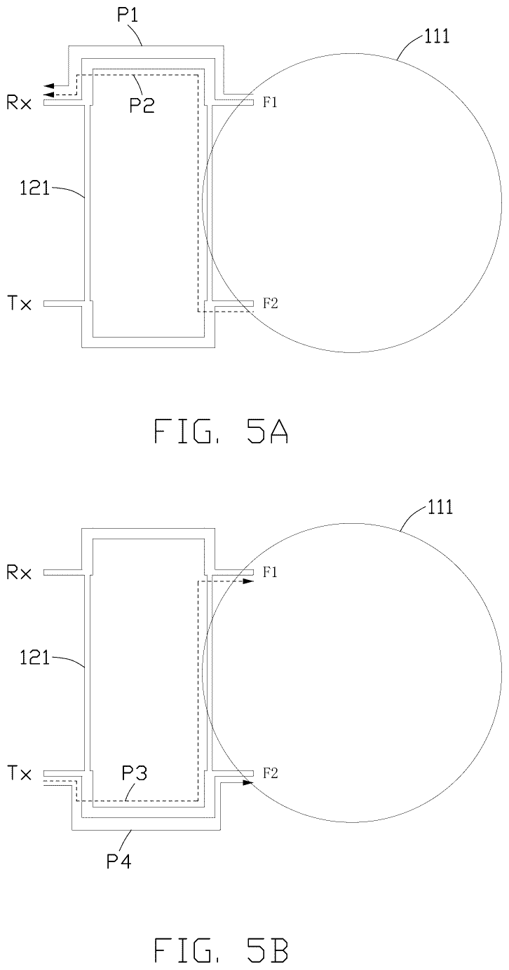

Please continue to refer to FIG. 4, the following content takes the structure of the radiator 111 connected with the corresponding phase coupler 121, LNA 18, transmitting beamforming unit 131 and receiving beamforming unit 132 shown in FIG. 4 as an example to continue to explain the working principle of the antenna device 10 provided in the present application.

In some embodiments, the radiator 111 is a circularly polarized antenna with dual feed points.

Each transmitting beamforming unit 131 includes a first phase shifter 1311, a first attenuator 1312, and a power amplifier 1313. Each receiving beamforming unit 132 includes a second attenuator 1321 and a second phase shifter 1322. In the transmitting beamforming unit 131, the first phase shifter 1311, the first attenuator 1312, and the power amplifier 1313 are connected in order, an output end of the power amplifier 1313 is connected to the phase coupler 121. In the receiving beamforming unit 132, the second attenuator 1321 is connected to the second phase shifter 1322, the second phase shifter 1322 is connected to the phase coupler 121 through the LNA 18. The first attenuator 1312 is used to adjust the microwave energy of the transmitting beamforming unit 131, and the second attenuator 1321 is used to adjust the microwave energy of the receiving beamforming unit 132. In this way, the first attenuator 1312 and the second attenuator 1321 can ensure that the power of each of the plurality of beamforming modules 13 is consistent, so as to improve the accuracy of beam synthesis and angle switching. The first phase shifter 1311 is used to adjust the phase shift of the microwave signal of the transmit beamforming unit 131, and the second phase shifter 1322 is used to adjust the phase shift of the microwave signal of the receive beamforming unit 132. In this way, the first phase shifter 1311 and the second phase shifter 1322 can ensure that the phase of each of the plurality of beamforming modules 13 is consistent, so as to improve the accuracy of beam synthesis and angle switching.

Please continue to refer to FIG. 5A and FIG. 5B, FIG. 5A shows current paths P1 and P2 on the phase coupler 121 when the radiator 111 is used as a receiving antenna. FIG. 5B shows current paths P3 and P4 on the phase coupler 121 when the radiator 111 is used as a transmitting antenna. Since the phase coupler 121 is a 90° phase coupler, the phase difference between the current (i.e., the current path P1) flowing from the first signal terminal F1 to the receiving port Rx and the current (i.e., the current path P2) flowing from the second signal terminal F2 to the receiving port Rx is 90°. The phase difference between the current (i.e., the current path P3) flowing from the transmitting port Tx to the first signal terminal F1 and the current (i.e., the current path P4) flowing from the transmitting port Tx to the second signal terminal F2 is also 90°.

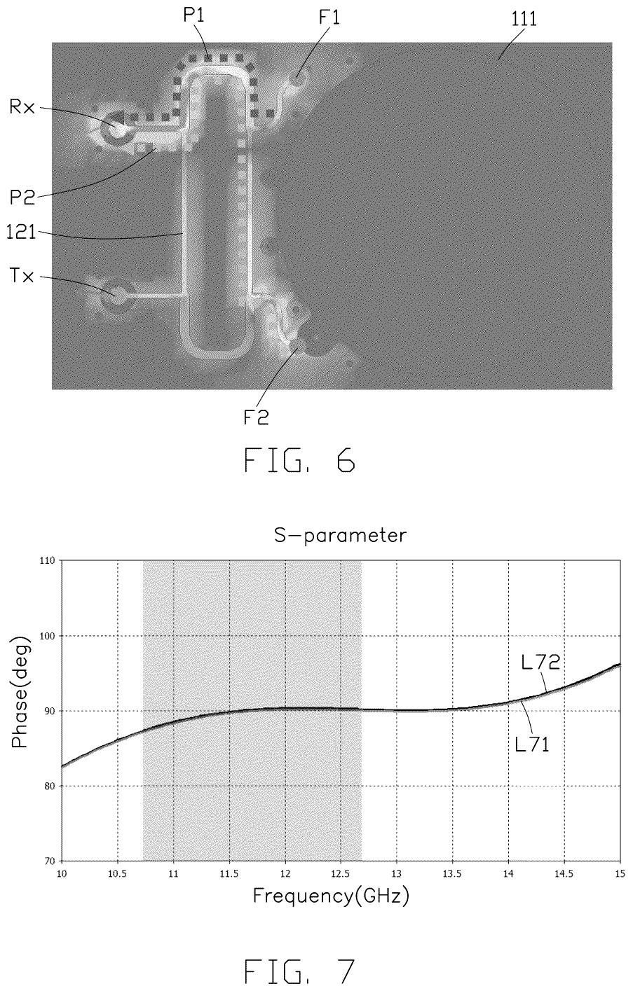

For example, please refer to FIG. 6, the current path P1 in FIG. 6 is used to represent the current path of the electrical signal of the first signal terminal F1 flowing to the receiving port Rx, and the current path P2 is used to represent the current path of the electrical signal of the second signal terminal F2 flowing to the receiving port Rx. According to FIG. 6, it can be seen that since the current phase on the current path P2 lags behind the current phase on the current path P1, when the current intensity of the second signal terminal F2 is strong, the current intensity of the first signal terminal F1 is weak.

For another example, please continue to refer to FIG. 7, which is a schematic diagram of the phase difference between the first signal terminal F1 and the second signal terminal F2 measured by the phase coupler 121 when the radiator 111 transmits/receives a wireless signal. In some embodiments, the operating frequency band of the radiator 111 is Ku band, wherein the operating frequency band of the radiator 111 when used to receive wireless signals is 10.7-12.7 GHZ, and the operating frequency band of the radiator 111 when used to transmit wireless signals is 14.0-14.5 GHz. When the operating frequency band of the radiator 111 is Ku band, and the current flows to the receiving port Rx through the first signal terminal F1 and the second signal terminal F2 respectively, it can be measured that the phase difference between the first signal terminal F1 and the second signal terminal F2 is approximately 90° (see curve L71); when the operating frequency band of the radiator 111 is Ku band and the current flows to the first signal terminal F1 and the second signal terminal F2 through the transmitting port Tx respectively, it can be measured that the phase difference between the first signal terminal F1 and the second signal terminal F2 is approximately 90° (see curve L72). From FIG. 7, the curves L71 and L72 maintain a stable 90° phase difference (e.g., a phase difference between 85° and) 95° in the Ku band. This indicates that when the radiator 111 transmits or receives a signal in the Ku band, the phase difference between the first signal end F1 and the second signal end F2 is approximately 90°, which meets the condition of exciting circularly polarized waves with a 90° phase difference (or a 0.25 wavelength difference) in the two electric fields.

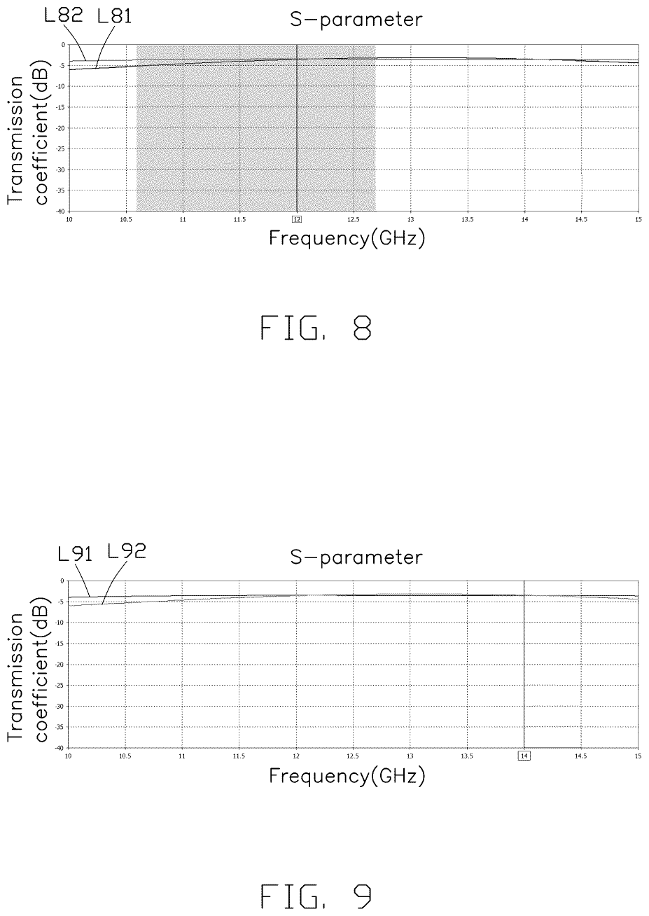

Referring to FIGS. 8 and 9, FIG. 8 illustrates transmission curves of the first signal terminal F1 and the second signal terminal F2 when the radiators 111 receiving wireless signals in the Ku band. An operating frequency band of the radiators 111 when receiving wireless signals is about 10.7-12.7 GHZ. Curve L81 is used to represent the transmission coefficient curve of the radiators 111 when receiving wireless signals in the Ku band, where the energy flows from the first signal terminal F1 to the receiving port Rx. Curve L82 is used to represent the transmission coefficient curve of the radiators 111 when receiving wireless signals in the Ku band, where the energy flows from the second signal terminal F2 to the receiving port Rx. FIG. 9 illustrates transmission curves of the first signal terminal F1 and the second signal terminal F2 when the radiators 111 transmitting wireless signals in the Ku band. An operating frequency band of the radiators 111 when transmitting wireless signals is about 14.0-14.5 GHz. Curve L91 is used to represent the transmission coefficient curve of the radiators 111 when transmitting wireless signals in the Ku band, where the energy flows from the transmitting port Tx to the first signal terminal F1. Curve L92 is used to represent the transmission coefficient curve of the radiators 111 when transmitting wireless signals in the Ku band, where the energy flows from the transmitting port Tx to the second signal terminal F2. From FIGS. 8 and 9, it can be seen that by connecting the radiators 111 through the phase couplers 121, the transmission coefficients of the first signal terminal F1 and the second signal terminal F2 can have a high degree of consistency when the radiators 111 receiving/transmitting wireless signals in Ku band, i.e., the energies of the first signal terminal F1 and the second signal terminal F2 are roughly equal when the radiator 111 receiving/transmitting signals, which meets the condition of output/input energy equal for exciting circularly polarized waves.

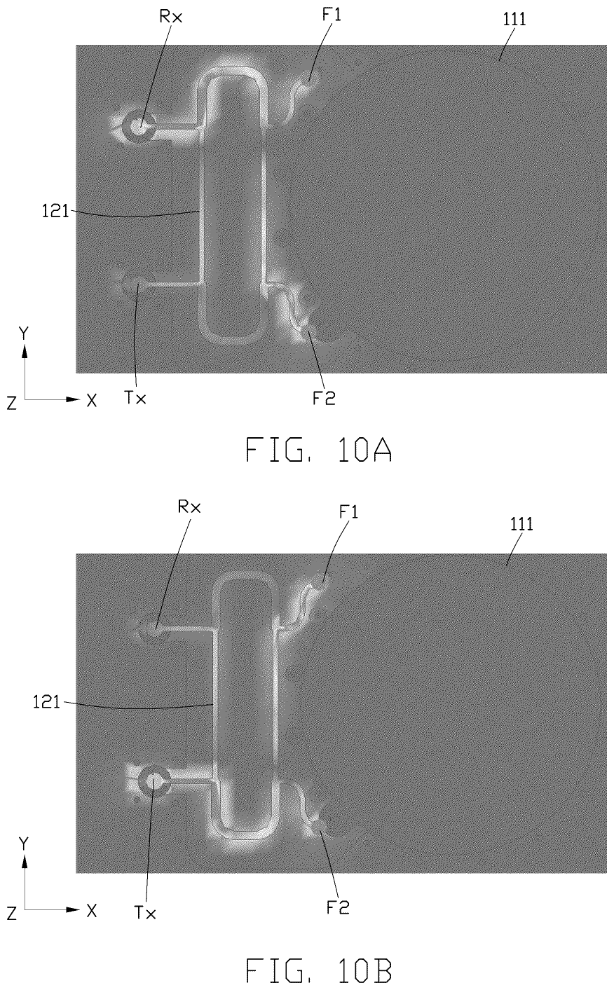

Referring to FIGS. 10A and 10B, FIG. 10A illustrates a current intensity distribution diagram of the phase coupler 121 when the energy of the first signal terminal F1 and the second signal terminal F2 flows to the receiving port Rx when the radiator 111 is used as a receiving antenna. FIG. 10B illustrates a current intensity distribution diagram of the phase coupler 121 when the energy flows from the transmitting port Tx to the first signal terminal F1 and the second signal terminal F2 when the radiator 111 is used as a transmitting antenna. As can be seen from FIG. 10A, when the energy of the first signal terminal F1 and the second signal terminal F2 flows to the receiving port Rx, the current distribution on the transmitting port Tx is relatively weak. As can be seen from FIG. 10B, when the energy flows from the transmitting port Tx to the first signal terminal F1 and the second signal terminal F2, the current distribution on the receiving port Rx is relatively weak. This indicates that the combination of the radiator 111 and the phase coupler 121 has a better isolation between the receiving port Rx and the transmitting port Tx.

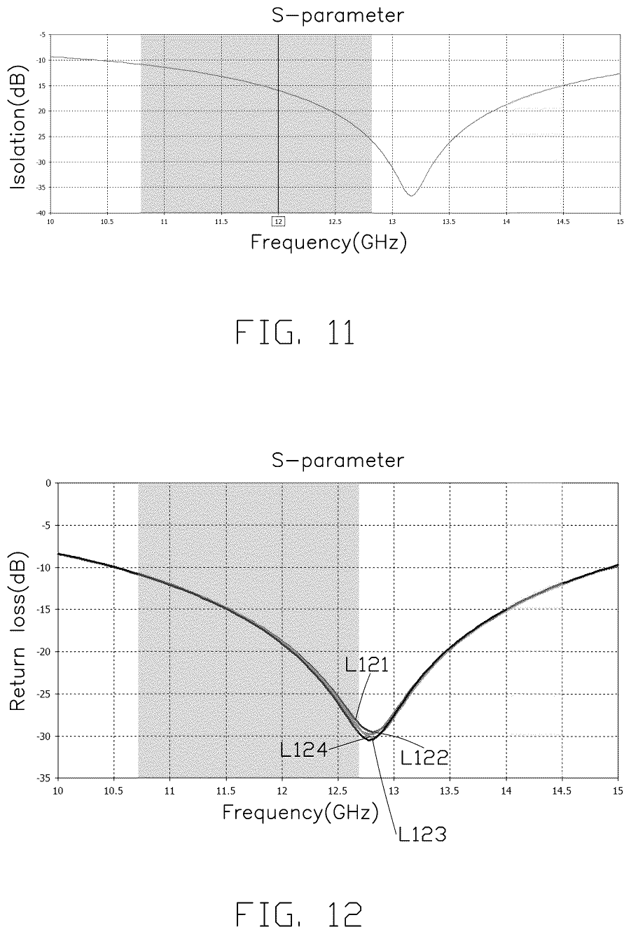

Referring to FIGS. 1 and 11, FIG. 11 illustrates a schematic diagram of an isolation curve between the receiving port Rx and the transmitting port Tx in the phase coupler 121 when the radiator 111 shown in FIG. 1 receives/transmits a wireless signal in the Ku band through the phase coupler 121. When the operating frequency band of the radiator 111 is the Ku band, the operating frequency band of the radiator 111 is 10.7-12.7 GHz when receiving the wireless signal, the operating frequency band of the radiator 111 is 14.0-14.5 GHz when transmitting the wireless signal. As can be seen from FIG. 11, when the combination of the radiator 111 and the phase coupler 121 is arranged to receive/transmit the wireless signal in the Ku band, the isolation between the receiving port Rx and the transmitting port Tx on the phase coupler 121 is greater than 10 dB.

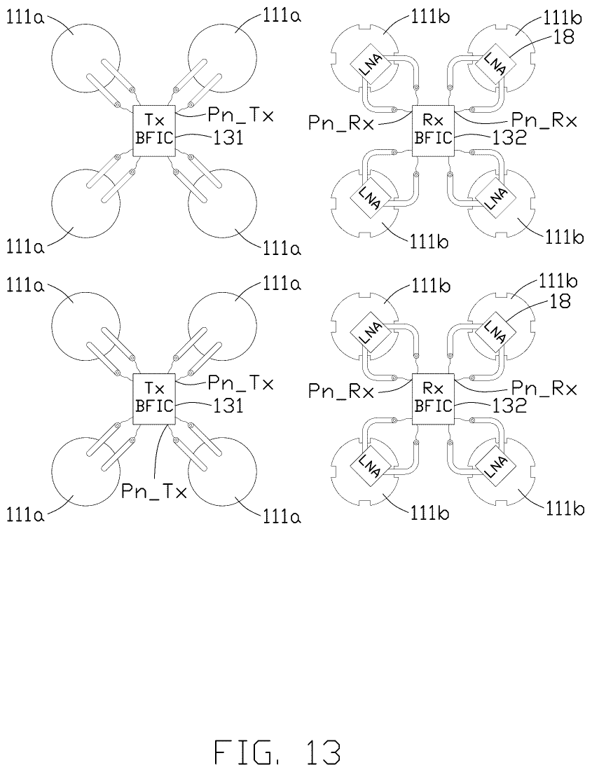

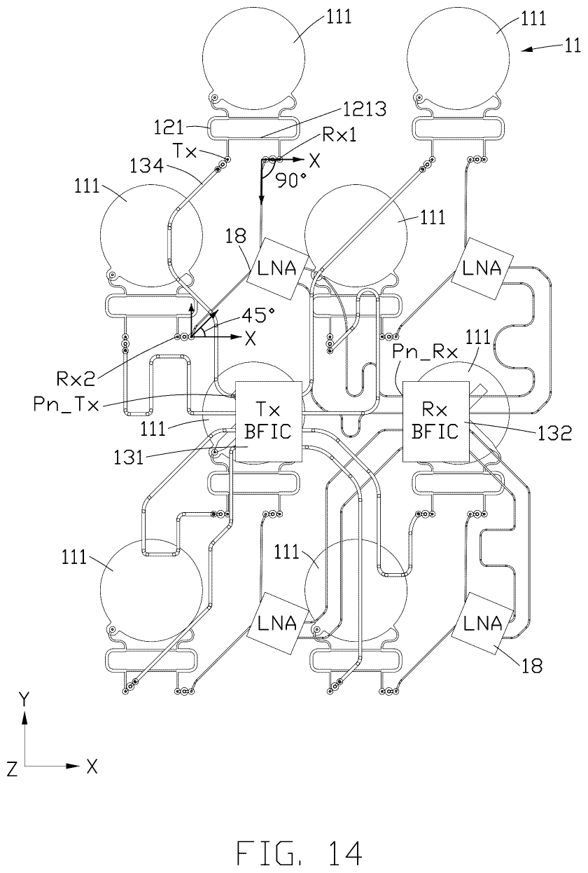

Referring to FIGS. 1 and 12, FIG. 12 illustrates a return loss curve of the receiving port Rx, the transmitting port Tx, the first signal terminal F1, and the second signal terminal F2 of the phase coupler 121 when the radiator 111 receives/transmits a wireless signal in the Ku band. When the operating frequency band of the radiator 111 is the Ku band, the operating frequency band of the radiator 111 is 10.7-12.7 GHz when receiving the wireless signal, the operating frequency band of the radiator 111 is 14.0-14.5 GHz when transmitting the wireless signal. Curve L121 is a return loss curve of the receiving port Rx; curve L122 is a return loss curve of the first signal terminal F1; curve L123 is a return loss curve of the second signal terminal F2; curve L124 is a return loss curve of the transmitting port Tx. It can be seen from FIG. 12 that the impedance bandwidth of the return loss of each port of the phase coupler 121 can reach the use bandwidth of the Ku band.

Thus, it can be clearly seen that the present application connects a radiator 111 through a phase coupler 121, and when a phase coupler 121 is respectively connected to a transmitting beamforming unit 131 and a receiving beamforming unit 132, the corresponding radiator 111 can excite circularly polarized waves. Specifically, when a phase coupler 121 is only connected to one group of signal terminals of the plurality of beamforming modules 13 (including a radio frequency output interface P1_Tx of a transmitting beamforming unit 131 and a radio frequency input interface P1_Rx of a receiving beamforming unit 132), the corresponding radiator 111 can excite circularly polarized waves.

Referring to FIGS. 13 and 14, FIG. 13 illustrates a schematic diagram of a circularly polarized antenna connected to a plurality of beamforming modules in the related art, and FIG. 14 illustrates a schematic diagram of eight combinations of radiators 111 and phase couplers 121 connected to the same transmitting beamforming unit 131 and the same receiving beamforming unit 132 shown in an embodiment of the present application. As can be seen from FIG. 14, each radiator 111 is connected to a radio frequency output interface Pn_Tx of a corresponding transmitting beamforming unit 131 and a radio frequency input interface Pn_Rx of a corresponding receiving beamforming unit 132 through a corresponding phase coupler 121. In this way, only one transmitting beamforming unit 131 and one receiving beamforming unit 132 are needed to enable eight radiators 111 to transmit/receive wireless signals through circularly polarized waves.

In the schematic diagram of a circularly polarized antenna connected to a plurality of beamforming modules in the prior art shown in FIG. 13, when the transmitting antenna and/or the receiving antenna are not connected to the phase coupler 121, each transmitting antenna 111a needs to be connected to at least two radio frequency output interfaces Pn_Tx in at least one transmitting beamforming unit (TxBFIC) to excite circularly polarized waves, and each receiving antenna 111b needs to be connected to at least two radio frequency input interfaces Pn_Rx in at least one receiving beamforming unit (RxBFIC) to excite circularly polarized waves. Thus, in FIG. 13, the eight antenna units (including eight transmitting antennas 111a and eight receiving antennas 111b) require at least two transmitting beamforming units (TxBFIC) 131 and two receiving beamforming units (RxBFIC) 132 so that the eight radiators 111 can transmit/receive wireless signals through circularly polarized waves. Obviously, in this application, a radiator 111 is connected to a transmitting beamforming unit 131 and a receiving beamforming unit 132 respectively through a phase coupler 121. In particular, a radiator 111 is connected to a radio frequency output interface Pn_Tx of the transmitting beamforming unit 131 and a radio frequency input interface Pn_Rx of the receiving beamforming unit 132 through a phase coupler 121, which can transmit/receive wireless signals with circularly polarized waves, which can significantly reduce the quantity of the transmitting beamforming unit 131 and the receiving beamforming units 132 in the antenna device 10, thereby reducing manufacturing costs.

Please refer to FIG. 14 again, in the present application, the plurality of radiators 111 are arranged in rows, in each row, every two adjacent radiators 111 are spaced apart by a preset distance. Every two adjacent rows of radiators 111 are staggered to form an array arrangement, that is, an array antenna. For instance, in an N+1^{th} row, each radiator 111 is staggered between two adjacent radiators 111 in an N^{th} row, where N is a positive integer greater than or equal to 1.

The phase coupler 121 is disposed corresponding to the radiator 111, and the phase coupler 121 is disposed between every two adjacent rows of radiators 111. The center of the radiator 111 and the center of the phase coupler 121 are substantially on a same straight line.

Taking the radiator 111 in the upper left corner of FIG. 14 as an example, in one embodiment of the present application, each radio frequency output interface Pn_Tx of the transmitting beamforming unit 131 may be connected to a corresponding transmitting port Tx of a phase coupler 121 via a corresponding connecting line 134. Similarly, each radio frequency input port Pn_Rx of the receiving beamforming unit 132 may be connected to the LNA 18 via the connecting line 134, and the LNA 18 is further connected to a corresponding receiving port Rx1 of the phase coupler 121 via the connecting line 134. In this embodiment, in order to further reduce the manufacturing cost of the antenna device 10, each two radio frequency input interfaces Pn_Rx of a receiving beamforming unit 132 are respectively connected to two receiving ports of two corresponding phase couplers 121, such as the receiving port Rx1 and the receiving port Rx2, through an LNA 18.

When the phases of the electrical signals output from the radio frequency output interface Pn_Tx of the same transmitting beamforming unit 131 to the transmitting ports Tx of the eight connected phase couplers 121 are the same and the output energy is the same, and when the phases of the electrical signals input from the receiving ports Rx of the eight phase couplers 121 to the radio frequency input interface Pn_Rx of the same receiving beamforming unit 132 are the same and the input energy is the same, it is more conducive to beamforming. Therefore, in the present application, the lengths of the connecting lines 134 connecting the same transmitting beamforming unit 131 to the plurality of transmitting ports Tx can be made the same, the lengths of the connecting lines 134 connecting the same LNA 18 to two receiving ports (e.g., Rx1 and Rx2) can be made the same, and the lengths of the connecting lines 134 connecting each radio frequency input interface Pn_Tx of the same receiving beamforming unit 132 to the corresponding LNA 18 can be made the same. In some embodiments, one end of the same LNA 18 is connected to a receiving beamforming unit 132, and the other end is connected to two receiving ports Rx (two different radiators 111).

In order to reduce energy loss, when the radiator 111 receives a wireless signal, it is required that the radiator 111 can amplify the wireless signal immediately. Thus, in the present application, the shorter the length of the connecting line 134 between the LNA 18 and the receiving port (such as Rx1 or Rx2) of the phase coupler 121, the more conducive to reducing the energy loss of the line. In the present application, in order to reduce line energy loss and ensure the same phase of two receiving ports (such as Rx1 or Rx2) connected to the same LNA 18, the connecting line 134 connecting the same LNA 18 to the two receiving ports (such as Rx1 or Rx2) is a straight line with the same length.

Specifically, taking the receiving port Rx1 and the receiving port Rx2 on the two radiators 111 in the upper left corner of FIG. 14 as an example, the receiving port Rx1 and the receiving port Rx2 are respectively connected to two radio frequency input interfaces Pn_Tx of the same receiving beamforming unit 132 through the same LNA 18. Taking a location of the receiving port Rx1 as the origin and a direction parallel to the first vertical section 1213 of the phase coupler 121 as the X-axis, the connecting line connecting the receiving port Rx1 to the LNA 18 is perpendicular to the X-axis. Taking a location of the receiving port Rx2 as the origin and a direction parallel to the first vertical section 1213 of the phase coupler 121 as the X-axis, the angle between the connecting line connecting the receiving port Rx2 to the LNA 18 and the X-axis is 45°. The LNA 18 for connecting the receiving port Rx1 and the receiving port Rx2 is disposed between the receiving port Rx1 and the receiving port Rx2, that is, the length of the connecting line 134 connecting the LNA 18 to the receiving port Rx1 is equal to the length of the connecting line 134 connecting the LNA 18 to the receiving port Rx2. Similarly, through the above-mentioned setting method, the setting position of each LNA 18 can be determined in turn.

Since the plurality of radiators 111 are regularly arranged in an array, the plurality of LNAs 18 are also regularly arranged in an array. Specifically, the plurality of LNAs 18 are arranged in rows, and in each row, every two adjacent LNAs 18 are arranged at the preset distance, and a radiator 111 located in the same row is arranged between every two adjacent LNAs 18. Every two adjacent rows of LNAs 18 are arranged correspondingly, and a row of radiators 111 is arranged between every two adjacent rows of LNAs 18.

In one embodiment of the present application, the transmitting beamforming unit 131 and the receiving beamforming unit 132 are arranged between every two adjacent rows of LNA 18, and each transmitting beamforming unit 131 is arranged between two corresponding LNAs 18. Each receiving beamforming unit 132 is arranged between two corresponding LNAs 18, and the two LNAs 18 are arranged in two adjacent rows. The connecting line between the transmitting beamforming unit 131 and the receiving beamforming unit 132 is substantially parallel to the radiator 111 in each row and the LNA 18 in each row. In other embodiments of the present application, the transmitting beamforming units 131, the receiving beamforming units 132, the radiators 111, and the LNAs 18 may be arranged according to actual arrangement requirements. The above arrangement is only one of all possible embodiments based on the inventive concept of the present application.

Specifically, taking a receiving beamforming unit 132 with eight radio frequency input interfaces Pn_Rx as shown in FIG. 14 as an example, the receiving beamforming unit 132 is connected to four LNAs 18. The four LNAs 18 form an array of two rows and two columns. A transmitting beamforming unit 131 is arranged between two LNAs 18 in the same column, and a receiving beamforming unit 132 is arranged between two LNAs 18 in another column.

The circuit layout of the antenna device 10 shown in FIG. 14 is only one embodiment of the present application. In other embodiments, corresponding adjustments may be made based on the circuit layout shown in FIG. 14, such as bending the connecting line 134, etc., the present application does not limit this.

In order to reduce the surface area of the antenna device 10, the circuit layout shown in FIG. 14 can be configured by using a multi-layer dielectric board and connected by vias. For example, each connecting line 134 connected to the beamforming module 13 (such as the transmitting beamforming unit 131 and the receiving beamforming unit 132) or the LNA 18 needs to adjust the path length consistency to ensure that the phase is the same and the output/input energy is the same, so as to facilitate the beam synthesis of the array, so there will be overlapping lines. Therefore, the circuit layout shown in FIG. 14 can use a multi-layer dielectric board to solve the technical problem of overlapping lines and reduce the area of the antenna device 10, which can effectively save space and make the product smaller.

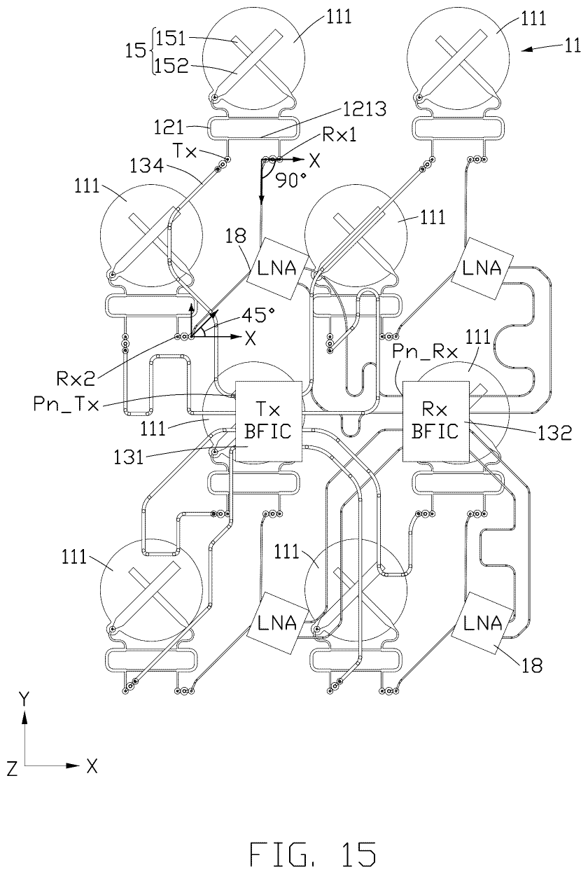

Please continue to refer to FIG. 15, in addition to the method of directly connecting the first signal terminal F1 and the second signal terminal F2 of the phase coupler 121 to the radiator 111 as shown in FIG. 14, in some embodiments, the first signal terminal F1 and the second signal terminal F2 of the phase coupler 121 can also feed electrical signals to the corresponding radiator 111 through a feeding portion 15, so that the impedance matching of the antenna device 10 can be optimized through the feeding portion 15. Taking FIG. 15 as an example, the antenna device 10 further includes a plurality of feeding portions 15. The plurality of feeding portions 15 are correspondingly connected to the plurality of radiators 111. Each of the plurality of feeding portions 15 includes a first feeding portion 151 and a second feeding portion 152, and each of the plurality of first feeding portions 151 corresponds to each of the plurality of second feeding portions 152 respectively. The plurality of first feeding portions 151 and the plurality of second feeding portions 152 may be located in different planes, respectively. Each of the phase couplers 121 is respectively connected to a transmitting beamforming unit 131 and a receiving beamforming unit 132. Each of the phase couplers 121 is correspondingly connected to each of the first feeding portions 151 and each of the second feeding portions 152. The plurality of phase couplers 121 also correspond one-to-one to the plurality of radiators 111. Specifically, the first signal terminal F1 of the corresponding phase coupler 121 is connected to one end of the first feeding portion 151, and the second signal terminal F2 is connected to one end of the second feeding portion 152. The first feeding portion 151 and the second feeding portion 152 are directly connected to two corresponding feeding points (not shown in FIG. 15) on the radiator 111. The first feeding portion 151 and the second feeding portion 152 cross each other, for example, they may be substantially perpendicular to each other. In this way, the projection areas of each first feeding portion 151 and each second feeding portion 152 on the corresponding radiator 111 at least partially overlap. For example, the first feeding portion 151 and the second feeding portion 152 may be staggered at an angle (eg, 90°) to form a cross shape. Accordingly, the projection area of each first feeding portion 151 and each second feeding portion 152 on the corresponding radiator 111 may also be in a cross shape. Since the phase difference between the electrical signals at the first signal terminal F1 and the second signal terminal F2 of the phase coupler 121 is 90°, the first feeding portion 151 can be used to transmit or receive one polarized wave, and the second feeding portion 152 can be used to transmit or receive another polarized wave with a phase difference of 90° to synthesize a circularly polarized wave. For example, when the first feed portion 151 and the second feed portion 152 excite horizontally polarized waves and vertically polarized waves respectively, circularly polarized waves can be synthesized. It can be understood that FIG. 15 only shows one arrangement of the first feed portion 151 and the second feed portion 152 in one embodiment of the present application. In other embodiments, the first feed portion 151 and the second feed portion 152 can also be arranged in other ways.

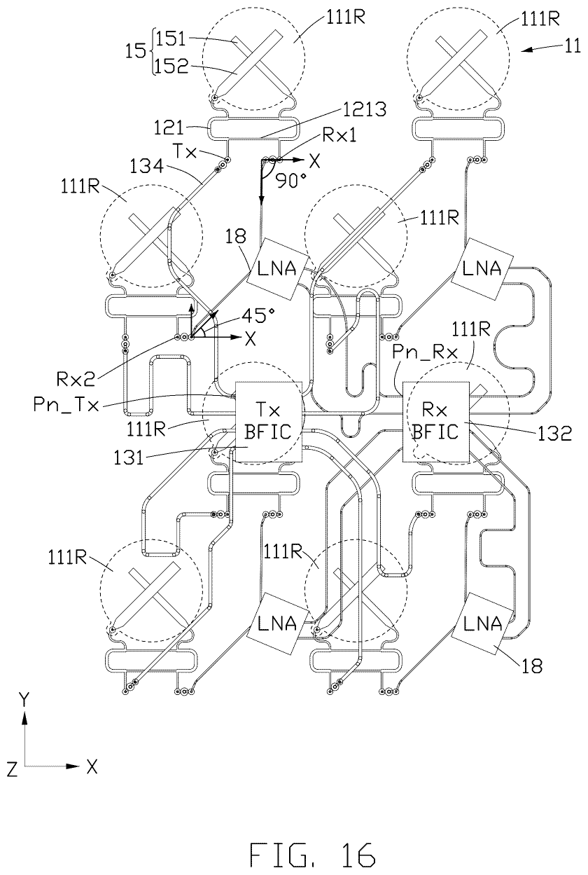

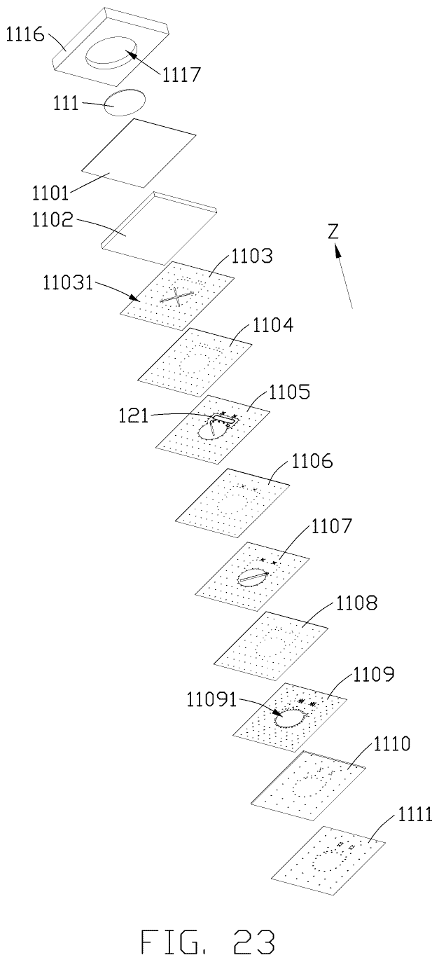

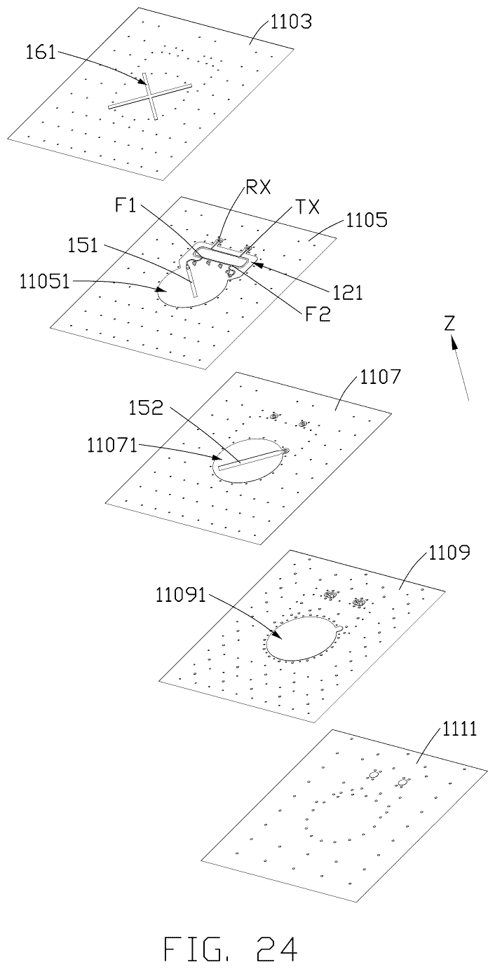

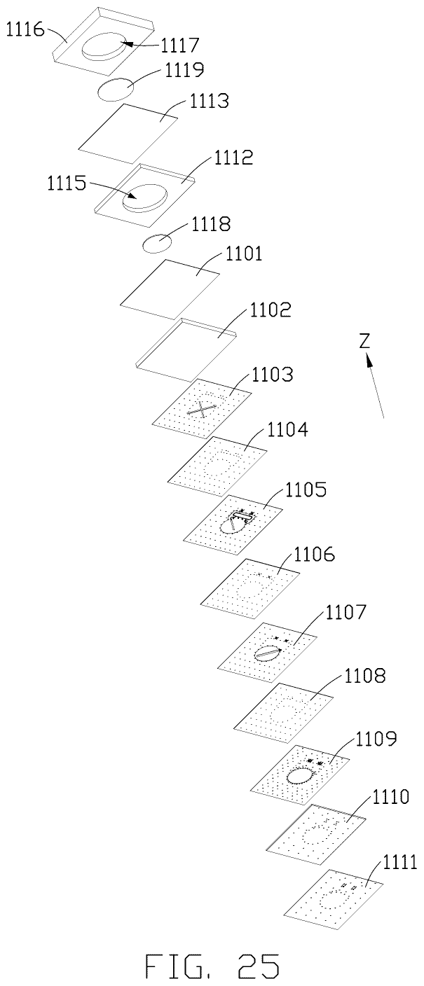

In other embodiments, the plurality of feeding portions 15 correspond to the plurality of radiators 111, respectively, and the plurality of feeding portions 15 can be coupled and connected to the plurality of radiators 111 one by one. In this way, when the plurality of feeding portions 15 are coupled with the corresponding radiators 111, the radiators 111 can also transmit or receive circularly polarized waves. For example, please refer to FIG. 16, the working principle of FIG. 16 is substantially the same as the working principle of FIG. 15. The difference is that the first feeding portion 151 and the second feeding portion 152 in each feeding portion 15 are arranged corresponding to a radiation area 111R, and each radiation area 111R is provided with a radiator and a coupling portion (not shown in FIG. 16, please refer to the coupling portion 16 in FIGS. 21 and 22), so that the first feeding portion 151 and the second feeding portion 152 are coupled and connected to the radiator in the radiation area 111R through the coupling portion. For example, the plurality of coupling portions can be a plurality of coupling slots (not shown in FIG. 16, please refer to the coupling slots 161 shown in FIG. 24, and the coupling slots mentioned in this paragraph below, please also refer to the coupling slots 161 shown in FIG. 24), and the plurality of coupling slots 161 are arranged one-to-one correspondingly to the plurality of first feeding portions 151 and the plurality of second feeding portions 152. Each coupling slot 161 may be a cross-coupling slot having a shape corresponding to that of at least a partial overlap between the first feeding portion 151 and the second feeding portion 152. Thus, after the first feeding portion 151 and the second feeding portion 152 are connected to the first signal terminal F1 and the second signal terminal F2 of the corresponding phase coupler 121, energy can be coupled to the radiator in the corresponding radiation region 111R through the coupling slot 161, thereby finally synthesizing a circularly polarized wave. For the specific structural settings, please refer to the detailed description of the relevant contents of FIG. 23 below in this application, which will not be repeated here.

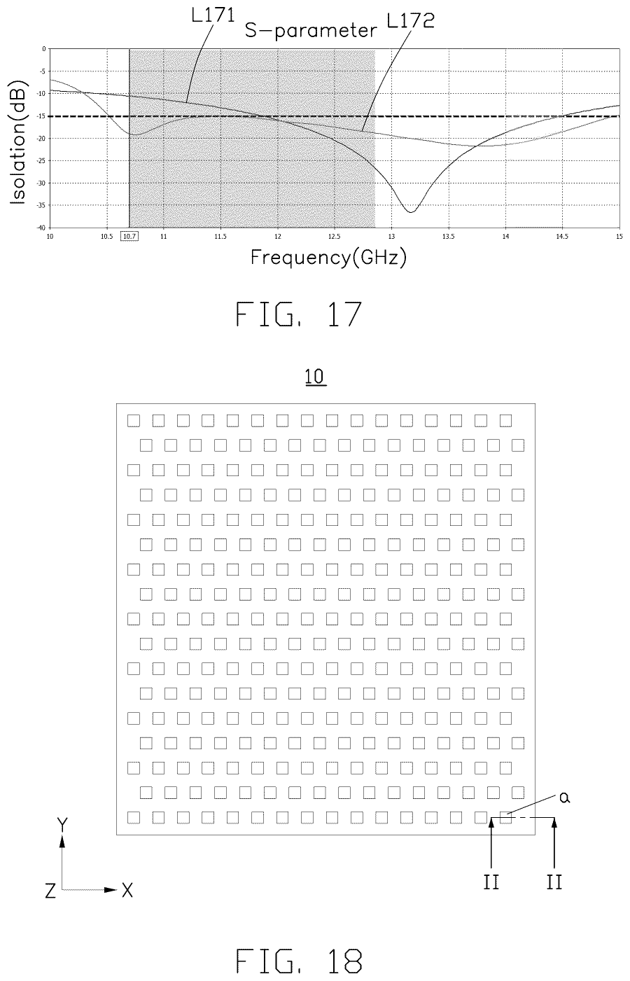

Referring to FIG. 17, curve L171 is an isolation curve between the transmitting port Tx and the receiving port Rx of the phase coupler 121 when the antenna device 10 including the phase coupler 121, but excluding the plurality of feeding portions 15 and the coupling portion. Curve L172 is an isolation curve between the transmitting port Tx and the receiving port Rx of the phase coupler 121 when the antenna device 10 including the phase coupler 121, the plurality of cross-shaped feeding portions 15 and the coupling portion. The first feeding portion 151 and the second feeding portion 152 in each feeding portion 15 form a cross-feed (i.e., the projection areas of each first feeding portion 151 and each second feeding portion 152 on the corresponding radiator 111 at least partially overlap), and the corresponding coupling portion is also a cross-coupling slot (e.g., the coupling slot 161 with a cross shape shown in FIG. 24). When the operating frequency band of the radiator 111 is Ku band, the operating frequency band of the radiator 111 for receiving wireless signals is 10.7-12.7 GHz, and the operating frequency band of the radiator 111 for transmitting wireless signals is 14.0-14.5 GHz. As can be seen from FIG. 17, in the antenna device 10, by providing a phase coupler 121, the plurality of cross-shaped feeding portions 15 and the plurality of coupling portions, not only can mutually perpendicular polarization distribution energy be provided, but also the isolation performance of the 10.7-12.7 GHz receiving frequency band can be greatly improved, from 10 dB to an isolation greater than 15 dB in the entire Ku band. The 10 dB isolation means that there is 10% mutual coupling between the transmitting port Tx and the receiving port Rx, and 15 dB isolation means that there is only 3% mutual coupling between the transmitting port Tx and the receiving port Rx.

Referring to FIGS. 14 and 15, the plurality of radiators 111 in the array antenna 11 of the embodiment can be used as a plurality of first radiators and a plurality of second radiators, wherein the plurality of first radiators and the plurality of second radiators are respectively disposed on different planes. The plurality of first radiators are correspondingly arranged with the plurality of second radiators. The plurality of first radiators are correspondingly arranged with the plurality of phase couplers, and the plurality of second radiators are correspondingly arranged with the plurality of phase couplers. For example, the radiator 111 mentioned in the embodiments of FIGS. 14 and 15 is used as a plurality of first radiators (please refer to the first radiator 1118 in FIG. 22), and the radiator 111 mentioned in the embodiments of FIGS. 14 and 15 is also used as a plurality of second radiators corresponding to the plurality of first radiators respectively (please refer to the second radiator 1119 in FIG. 22). Since the plurality of first radiators and the plurality of second radiators are correspondingly arranged and the plurality of first radiators and the plurality of second radiators are respectively arranged in different planes, energy coupling can be achieved between the first radiators and the corresponding second radiators, so that the first radiators in the above embodiments can form a resonant cavity together with the corresponding second radiators to realize the transmission of wireless signals. Similarly, the radiation area 111R of FIG. 16 may include a plurality of first radiators correspondingly arranged with a plurality of second radiators, which will not be described in detail. The embodiments of the first radiators and the second radiators can be described in detail in the embodiments of FIGS. 22 and 25.

In summary, the antenna device 10 provided in the present application connects the plurality of radiators 111 in the antenna device 10 and the plurality of beamforming units in the beamforming module 13 through the plurality of phase couplers 12, and the phase coupler 121 is a 90-degree power divider, and the radiator 111 is a circularly polarized antenna. In this way, a radiator 111 is connected to only one radio frequency output interface Pn_Tx of a transmitting beamforming unit 131 and one radio frequency input interface Pn_Rx of a receiving beamforming unit 132 through a phase coupler 121, so that the phase coupler 121 can output two electrical signals with a phase difference of 90 degrees and equal amplitude to the corresponding radiator 111, or receive two electrical signals with a phase difference of 90 degrees and equal amplitude from the radiator 111, so that the circular polarization effect is stimulated when the antenna device 10 receives or transmits wireless signals, effectively reducing the quantity of beamforming units in the antenna device 10, thereby reducing the design area and manufacturing cost of the antenna device 10, which is conducive to the miniaturization design of the product.

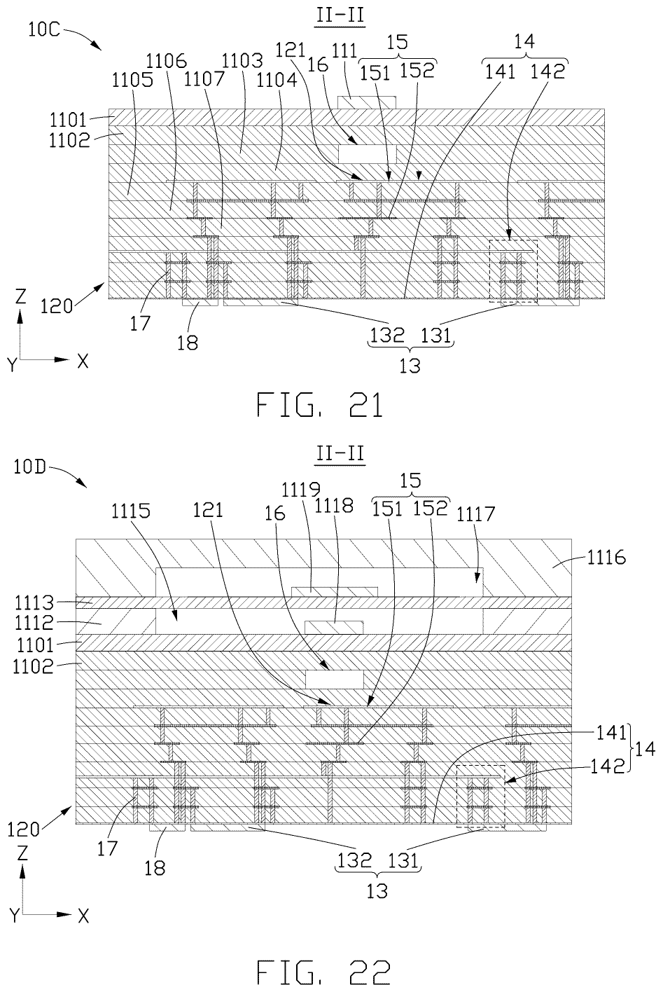

Referring to FIGS. 18 and 19, FIG. 18 illustrates an overall schematic diagram of an antenna device 10 provided in one embodiment of the present application. The antenna device 10 is configured by stacking a multi-layer structure (e.g., a multi-layer structure 10A shown in FIG. 19, a multi-layer structure 10B shown in FIG. 20, a multi-layer structure 10C shown in FIG. 21, and a multi-layer structure 10D shown in FIG. 22).

The plurality of radiators 111 (not shown in FIG. 18) in the antenna device 10 together form an array antenna including a plurality of subunits a on the antenna device 10, and each subunit a includes a radiator 111 as described in any of the above embodiments. In the following embodiments, the structural schematic diagram along a section line II-II of one of the subunits a is taken as an example to illustrate the multi-layer structure involved in the antenna device 10 of the present application.

Referring to FIG. 19, FIG. 19 illustrates a cross-sectional view of the subunit a when the antenna device 10 of FIG. 18 adopts the multi-layer structure 10A in one embodiment of the present application. Since FIGS. 19 to 22 only exemplarily show schematic diagrams of one subunit a on the antenna device 10, each of FIGS. 19 to 21 only exemplarily shows one radiator 111 and the correspondingly connected phase coupler 121. In addition, each of FIGS. 19 to 21 only exemplarily shows a part of the number of layers to illustrate the technical concept of the present application, and the actual number of layers can be adjusted according to needs.

The array antenna 11 (i.e., the plurality of radiators 111) of FIG. 1 may be disposed in at least one layer of the multi-layer structure 10A of FIG. 19. The plurality of phase couplers 121 are disposed in at least one layer of the multi-layer structure 10A. In some embodiments, the plane layer where the array antenna 11 is located is different from the plane layer where the plurality of phase couplers 121 are located. The plurality of phase couplers 121 correspond one-to-one to the plurality of radiators 111.

For instance, in the embodiment of FIG. 19, the multi-layer structure 10A of the subunit a (as shown in FIG. 18) at least includes a first radiation layer 1101, a first dielectric layer 1102, and a first feeding layer 1105. FIG. 19 only shows that the multi-layer structure 10A of the subunit a of FIG. 18 includes a radiator 111. That is, the antenna device 10 of FIG. 18 includes a multi-layer structure 10A of a plurality of subunits a, and the multi-layer structure 10A having a plurality of subunits a may include a plurality of radiators 111, and the other elements are similar, and will not be described in detail here. That is, the multi-layer structure 10A having the plurality of subunits a may include at least one radiation layer (e.g., the first radiation layer 1101), at least one radiation layer is disposed in at least one layer of the multi-layer structure 10A, at least one radiation layer is disposed with the plurality of radiators 111, and other elements are analogous, which will not be described in detail here. In addition, FIG. 19 only exemplarily shows a part of the number of layers to illustrate the technical concept of the present application, and the actual number of layers can be adjusted according to needs. The first radiation layer 1101 and the first feeding layer 1105 may be printed circuit boards, or boards made of ceramic materials or plastic materials. The first dielectric layer 1102 is made of a non-conductive material. For example, in some embodiments, the first dielectric layer 1102 may be made of a material with a dielectric constant of about 2.4, specifically, may be made of a ceramic material or a plastic material. Each radiator 111 is disposed on the first radiating layer 1101. The radiator 111 may be a metal coating or other sheet made of a conductive material formed on the first radiating layer 1101. The radiator 111 is formed on a surface of the first radiating layer 1101 away from the first dielectric layer 1102. Each radiator 111 serves as a receiving antenna at a first moment and as a transmitting antenna at a second moment. Each phase coupler 121 is disposed on a surface of the first feeding layer 1105 on a side close to the first dielectric layer 1102. Each phase coupler 121 is corresponded to each radiator 111. In some embodiments, the radiator 111 is a substantially circular copper sheet. The first radiating layer 1101, the first dielectric layer 1102, and the first feeding layer 1105 are all substantially square. The areas of the first radiating layer 1101, the first dielectric layer 1102, and the first feeding layer 1105 are all larger than the area of the first radiator 1118.

The multi-layer structure 10A further includes a multi-layer circuit board 120 stacked in sequence. The material of each circuit board can be substantially the same as the material of the first radiation layer 1101, which will not be described in detail herein. The plurality of transmit beamforming units 131 and the plurality of receive beamforming units 132 of the beamforming module 13, the plurality of LNAs 18, the first multiplexer 141 and the second multiplexer 142 of the plurality of multiplexers 14 are disposed on the multi-layer circuit board 120.

Specifically, the beamforming module 13 includes a plurality of beamforming units, and the plurality of beamforming units include a plurality of transmitting beamforming units 131 and a plurality of receiving beamforming units 132. That is, the plurality of beamforming units (such as the transmitting beamforming units 131 and the receiving beamforming units 132 in FIG. 19) are disposed on a surface layer of the multi-layer circuit board 120 away from the first radiation layer 1101, so that the plurality of beamforming units are at least disposed on a surface layer in the multi-layer structure 10A. Each phase coupler 121 is respectively connected to a transmitting beamforming unit 131 and a receiving beamforming unit 132. Each layer of the multi-layer structure 10A in the antenna device 10 can be provided with a via 17, and the connecting lines (not shown) of the transmitting beamforming unit 131 and the receiving beamforming unit 132 are electrically connected from the surface layer of the multi-layer structure 10A to the phase coupler 121 located in the inner layer of the multi-layer structure 10A through the via 17, and the phase coupler 121 is further connected to the corresponding radiator 111. The connecting line (not shown) of the receiving beamforming unit 132 may be first connected to the LNA 18 on the surface of the antenna device 10, and then electrically connected from the LNA 18 to the phase coupler 121 through the via 17.

The multi-layer circuit board 120 is also used to carry the plurality of multiplexers 14. The plurality of multiplexers 14 are distributed in different plane layers in the multi-layer structure 10A. The plurality of multiplexers 14 are connected to the beamforming module 13. The plurality of multiplexers 14 are used to connect the plurality of transmitting beamforming units 131 or the plurality of receiving beamforming units 132 in parallel. Specifically, the plurality of multiplexers 14 include a plurality of first multiplexers 141 and a plurality of second multiplexers 142. The plurality of first multiplexers 141 are used to connect the plurality of transmit beamforming units 131, and the plurality of second multiplexers 142 are used to connect the plurality of receive beamforming units 132. The plurality of first multiplexers 141 are a plurality of same-layer multiplexers, each of which is distributed in the same plane layer in the multi-layer structure 10A. The plurality of second multiplexers 142 are a plurality of multi-layer multiplexers, each of which is distributed in a different plane layer in the multi-layer structure 10A. For example, in FIG. 19, the first multiplexer 141 is disposed on the surface layer of the multi-layer structure 10A, and the second multiplexers 142 can be formed on the plurality of plane layers of the multi-layer structure 10A. Specifically, the second multiplexers 142 can be formed on the surface layer and other plane layers of the multi-layer structure 10A (for example, please refer to FIG. 3B for the technical concept of the second multiplexers 142 belonging to the multi-layer multiplexer).

For the specific circuit connection relationship and working principle of the antenna device 10, please refer to the description of the relevant content above, which will not be repeated here. Each radiator 111 and a corresponding phase coupler 121, each phase coupler 121 and a corresponding transmitting beamforming unit 131, each phase coupler 121 and a corresponding LNA 18, each LNA 18 and a corresponding receiving beamforming unit 132, each transmitting beamforming unit 131 and the corresponding plurality of first multiplexers 141, the plurality of first multiplexers 141 forming a cascade circuit structure, each receiving beamforming unit 132 and the corresponding plurality of second multiplexers 142, the plurality of second multiplexers 142 forming a cascade circuit structure can be electrically connected through the via 17, which will not be repeated here.

Thus, in the multi-layer structure 10A shown in FIG. 19, a corresponding radiator 111 is electrically connected to a corresponding transmitting beamforming unit 131 and a receiving beamforming unit 132 of the beamforming module 13 through each phase coupler 121, and the phase coupler 121 is a 90-degree power divider, and the radiator 111 is a circularly polarized antenna. In this way, each phase coupler 121 can transmit two electrical signals with a phase difference of 90 degrees between the plurality of beamforming modules 13 and the plurality of radiators 111, so that each radiator 111 is connected to only one radio frequency output interface (not shown in FIG. 19) of a transmitting beamforming unit 131 and one radio frequency input interface (not shown in FIG. 19) of a receiving beamforming unit 132 through one phase coupler 121, so that the circular polarization effect can be stimulated when the antenna device 10 receives or transmits a wireless signal, which effectively reduces the quantity of beamforming modules in the antenna device 10, thereby reducing the design area and manufacturing cost of the antenna device 10, which is conducive to realizing the miniaturization design of the product. Furthermore, by adopting the stacked multi-layer structure 10A shown in FIG. 19, the design area of the antenna device 10 can be further reduced.

Referring to FIG. 20, FIG. 20 illustrates a cross-sectional view of the subunit a when the antenna device 10 of FIG. 18 adopts the multi-layer structure 10B in one embodiment of the present application. FIG. 20 only illustrates that the multi-layer structure 10B of the subunit a of FIG. 18 includes a radiator 111. That is, the antenna device 10 of FIG. 18 includes the multi-layer structure 10B of the plurality of subunits a, and the multi-layer structure 10B with the plurality of subunits a may include the plurality of radiators 111, and the other elements are similar, and will not be described in detail here. That is, the multi-layer structure 10B having the plurality of subunits a may include at least one radiation layer (for example, a first radiation layer 1101), at least one radiation layer is arranged in at least one layer of the multi-layer structure 10B, and the at least one radiation layer is provided with the plurality of radiators 111. In addition, FIG. 20 only exemplarily shows a part of the number of layers to illustrate the technical concept of the present application, and the actual number of layers can be adjusted as required. The structure of the multi-layer structure 10B is substantially the same as that of the multi-layer structure 10A, except that the multi-layer structure 10B further includes the plurality of feeding portions 15. The plurality of feeding portions 15 are correspondingly connected to the plurality of radiators 111, respectively, that is, each phase coupler 121 is also connected to the radiator 111 through the feeding portion 15.

Each feeding portion 15 includes a first feeding portion 151 and a second feeding portion 152. The first feeding portion 151 and the second feeding portion 152 are respectively disposed in different plane layers in the multi-layer structure 10B. The first feeding portion 151 and the second feeding portion 152 are correspondingly disposed, respectively. The projection areas of each first feeding portion 151 and each second feeding portion 152 on the corresponding radiator 111 at least partially overlap. For example, the first feeding portion 151 and the second feeding portion 152 may be staggered at an angle to form a cross-shaped projection (see FIG. 23 for details, which will not be described in detail here). Accordingly, in the multi-layer structure 10B, a second feeding layer 1107 is further provided corresponding to the plurality of feeding portions 15, and a first dielectric body 1106 is provided between the first feeding layer 1105 and the second feeding layer 1107. Each first feeding portion 151 is provided on the first feeding layer 1105, and each second feeding portion 152 is provided on the second feeding layer 1107. That is, the multi-layer structure 10B having the plurality of subunits a may include the first feeding layer 1105 and the second feeding layer 1107, which are arranged in different plane layers in the multi-layer structure 10B, wherein the first feeding layer 1105 includes the plurality of first feeding portions 151, and the second feeding layer 1107 includes the plurality of second feeding portions 152, and the plurality of first feeding portions 151 and the plurality of second feeding portions 152 are correspondingly arranged.

Each first feeding portion 151 and the corresponding phase coupler 121 are disposed corresponding to the corresponding radiator 111, and each first feeding portion 151 and each phase coupler 121 are disposed on the same plane layer, that is, both are disposed on the surface of the first feeding layer 1105 away from the first dielectric body 1106. Each second feeding portion 152 is also disposed corresponding to the radiator 111. The second feeding portions 152 are disposed on a surface of the second feeding layer 1107 close to the first dielectric body 1106. Each phase coupler 121 connects each first feeding portion 151 and each second feeding portion 152 correspondingly.

Specifically, one end of the first feeding portion 151 is connected to the first signal terminal F1 of the phase coupler 121, one end of the second feeding portion 152 is connected to the second signal terminal F2 through the via 17, and the other end of the first feeding portion 151 and the other end of the second feeding portion 152 are respectively connected to two feeding points on the radiator 111 through vias. In this way, in the multi-layer structure 10B, the impedance matching of the antenna device 10 can be further optimized through the first feeding portion 151 and the second feeding portion 152.

Referring to FIG. 21, FIG. 21 illustrates a cross-sectional view of the subunit a when the antenna device 10 of FIG. 18 adopts a multi-layer structure 10C in one embodiment of the present application. FIG. 21 only shows that the multi-layer structure 10C of the subunit a of FIG. 18 includes a radiator 111. In other words, the antenna device 10 of FIG. 18 includes the multi-layer structure 10C of the plurality of subunits a, and the multi-layer structure 10C with the plurality of subunits a can include the plurality of radiators 111, and the other components are similar, and will not be described in detail here. That is, the multi-layer structure 10C having the plurality of subunits a may include at least one radiation layer (e.g., the first radiation layer 1101), at least one radiation layer is disposed in at least one layer of the multi-layer structure 10C, at least one radiation layer is disposed with the plurality of radiators 111, and other elements are analogous, which will not be described in detail herein. In addition, FIG. 21 only exemplarily shows a part of the number of layers to illustrate the technical concept of the present application, and the actual number of layers can be adjusted according to requirements. The structure of the multi-layer structure 10C is substantially the same as that of the multi-layer structure 10B, except that the multi-layer structure 10C further includes coupling portions 16. The feeding portions 15 are correspondingly arranged with the coupling portions 16. The phase couplers 121 are correspondingly connected with the feeding portions 15, and the feeding portions 15 are coupled and correspondingly connected with the radiators 111 through the coupling portions 16. That is, in FIG. 21, the projection of the radiator 111 along the Z-axis direction of the antenna device 10 forms a radiation area 111R (see FIG. 16), and the radiation area 111R covers the projection of the corresponding first feeding portion 151, the second feeding portion 152, and the coupling portion 16 in the Z-axis direction. In this way, the feeding portions 151 and the radiation areas 111R are correspondingly arranged, respectively, so that the energy of the first feeding portion 151 and the second feeding portion 152 can be coupled to the radiator 111 through the coupling portion 16.

Accordingly, corresponding to the coupling portion 16, a coupling layer 1103 and a second dielectric body 1104 disposed between the coupling layer 1103 and the first feeding layer 1105 are further disposed in the multi-layer structure 10C. The coupling layer 1103 is disposed on a side of the first dielectric layer 1102 away from the first radiation layer 1101.

The coupling layer 1103 is provided with a coupling slot (for example, the coupling slot 161 shown in FIG. 24, for the coupling slots mentioned below in this paragraph, please also refer to the coupling slot 161 shown in FIG. 24) as the coupling portion 16, so that the energy of the first feeding portion 151 and the second feeding portion 152 can be coupled to the radiator 111 through the coupling slot 161. That is, the plurality of coupling slots 161 are disposed on the same plane layer (e.g., coupling layer 1103) in the multi-layer structure 10C. The plurality of coupling slots 161 are disposed one-to-one correspondingly with the plurality of first feeding portions 151 and the plurality of second feeding portions 152. In some embodiments, corresponding to the cross-shaped first feeding portions 151 and the second feeding portions 152, the coupling slots 161 provided on the coupling layer 1103 may be cross-shaped coupling slots.

Referring to FIG. 22, FIG. 22 illustrates a cross-sectional view of the subunit a when the antenna device 10 of FIG. 18 adopts the multi-layer structure 10D in one embodiment of the present application. That is, the antenna device 10 of FIG. 18 includes the multi-layer structure 10D having the plurality of subunits a. The multi-layer structure 10D having the plurality of subunits a may include the plurality of radiators, and the same applies to other elements, which will not be described in detail here. That is, the multi-layer structure 10D having the plurality of subunits a may include a first radiation layer 1101 and a second radiation layer 1113 arranged in different planar layers in the multi-layer structure 10D, the plurality of radiators include a plurality of first radiators and a plurality of second radiators, the first radiation layer 1101 includes the plurality of first radiators 1118, the second radiation layer 1113 includes the plurality of second radiators 1119, and the same applies to other elements, which will not be repeated here. In addition, FIG. 22 only shows a part of the number of layers to illustrate the technical concept of the present application, and the actual number of layers can be adjusted according to demand. The structure of the multi-layer structure 10D is substantially the same as that of the multi-layer structure 10C, except that the multi-layer structure 10D includes two radiation layers. That is, at least one radiation layer in the multi-layer structure 10D may include the first radiation layer 1101 and the second radiation layer 1113 disposed in different plane layers in the multi-layer structure. On the basis of the multi-layer structure 10C, the multi-layer structure 10D further includes a second radiation layer 1113, and a second dielectric layer 1112 disposed between the first radiation layer 1101 and the second radiation layer 1113. The second dielectric layer 1112 is disposed on the side of the first radiation layer 1101 on which the radiator (i.e., the first radiator 1118 in FIG. 22) is disposed. The second radiation layer 1113 is disposed on the side of the second dielectric layer 1112 away from the first radiation layer 1101. Another radiator is also disposed on the second radiation layer 1113. Hereinafter, for the convenience of description, the radiator on the first radiating layer 1101 is defined as the first radiator 1118, and the radiator on the second radiating layer 1113 is defined as the second radiator 1119. That is, the plurality of radiators in the array antenna include at least one first radiator 1118 and at least one second radiator 1119. The first radiator 1118 is disposed on the first radiating layer 1101, and the second radiator 1119 is disposed on the second radiating layer 1113. The first radiator 1118, the second radiator 1119, and the phase coupler 121 are correspondingly disposed, respectively.

The projection area of the second radiator 1119 in the Z direction of the antenna device 10 covers the projection area of the corresponding first radiator 1118 in the Z direction of the antenna device 10. The projection area of the first radiator 1118 in the Z direction of the multi-layer structure 10D covers the projection areas of the first feeding portion 151, the second feeding portion 152 and the coupling slot 161 (not shown in FIG. 22, see FIG. 24) in the Z direction of the multi-layer structure 10D.

A cavity 1115 is defined on the second dielectric layer 1112, and a first radiator 1118 is disposed in the cavity 1115.

Furthermore, compared with the multi-layer structure 10C, the multi-layer structure 10D further includes a radome 1116. The radome 1116 is disposed on the second radiation layer 1113 on a side close to the second radiator 1119. The radome 1116 is used to protect the components in the antenna device 10 from being exposed to the sun, rain, and dust, so as to improve the working stability of the antenna device 10. In this embodiment, the radome 1116 is also provided with a protective cavity 1117 corresponding to the second radiator 1119. For example, the protective cavity 1117 may be formed by a side of the radome 1116 close to the second radiator 1119 being recessed inward, and the protective cavity 1117 may be substantially cylindrical. In this way, the weight of the antenna device 10 may be reduced. In other embodiments, the multi-layer structure 10D may not be provided with the radome 1116, that is, the radome 1116 may be provided according to actual needs.

The radome 1116 can also be disposed on the multi-layer structure 10A, the multi-layer structure 10B and the multi-layer structure 10C according to actual needs, for example, disposed on the side of the first radiation layer 1101 close to the first radiator 1118, which will not be repeated here.

In summary, the antenna device 10 provided in the embodiment of the present application can further reduce the surface area occupied by the antenna device 10 by adopting the multi-layer structure with a stacked arrangement (for example, the multi-layer structure 10A-10D).

In order to more clearly introduce the stacked multi-layer structure of the antenna device 10 provided in the present application, the partial exploded schematic diagrams of the multi-layer structure 10C shown in FIG. 21 and the multi-layer structure 10D shown in FIG. 22 will be further introduced below.

Referring to FIGS. 23 and 24, FIG. 23 illustrates a partial exploded schematic diagram of the multi-layer structure 10C (see FIG. 21) in an embodiment of the present application. In addition, FIGS. 23 and 24 only exemplarily show a part of the number of layers to illustrate the technical concept of the structure of FIG. 21 of the present application, and the actual number of layers can be adjusted according to demand.

In some embodiments, the multi-layer structure 10C under the architecture of FIG. 21 shown in FIG. 23 may include the first radiation layer 1101 and the first dielectric layer 1102 that are stacked. The first radiation layer 1101 includes the radiator 111. The phase couplers 121 are correspondingly arranged with the radiators 111. Each radiator 111 can be used as a receiving antenna at a first moment and as a transmitting antenna at a second moment. In some embodiments, the first radiation layer 1101 may be a printed circuit board, or a plate made of a ceramic material or a plastic material. The radiator 111 may be a metal coating or other sheet made of a conductive material formed on the first radiation layer 1101. The radiator 111 is formed on the surface of the first radiation layer 1101 away from the first dielectric layer 1102. The first dielectric layer 1102 is made of a non-conductive material. For example, in some embodiments, the first dielectric layer 1102 may be made of a material with a dielectric constant of about 2.4, specifically, may be made of a ceramic material or a plastic material. The areas of the first radiation layer 1101 and the first dielectric layer 1102 are both larger than the area of the radiator 111.

In some embodiments, the antenna device 10 further includes the coupling layer 1103, the second dielectric body 1104, the first feeding layer 1105, the first dielectric body 1106, and the second feeding layer 1107 which are stacked.

The coupling layer 1103 is disposed close to the first dielectric layer 1102, specifically, on a side of the first dielectric layer 1102 away from the first radiation layer 1101. The coupling layer 1103 is provided with the coupling slot 161 (see FIG. 24) to serve as the coupling portion 16 (see FIG. 21).

The second dielectric body 1104 is arranged on a side of the coupling layer 1103 away from the first dielectric layer 1102.

The first feeding layer 1105 is disposed on a side of the second dielectric body 1104 away from the coupling layer 1103. Please refer to FIG. 23 and FIG. 24, the first feeding layer 1105 is provided with a first receiving groove 11051, and the first receiving groove 11051 penetrates the first feeding layer 1105. The first feeding layer 1105 includes the phase coupler 121 and the first feeding portion 151. Each first feeding portion 151 is respectively disposed in a corresponding first receiving groove 11051. The phase coupler 121 can be disposed in the first feeding layer 1105 or the second feeding layer 1107. In the present embodiment, the phase coupler 121 is disposed in the first receiving groove 11051 of the first feeding layer 1105. The first feeding portion 151 is a microstrip line that is substantially in the shape of an elongated strip. The phase coupler 121 is a metal ring that is substantially in the shape of a square ring. The first receiving groove 11051 includes a square groove and a circular groove that are interconnected. The phase coupler 121 is disposed in the square groove of the first receiving groove 11051, and the first feeding portion 151 is disposed in the circular groove of the first receiving groove 11051.

The first dielectric body 1106 is arranged on a side of the first feeding layer 1105 away from the second dielectric body 1104.

The second feeding layer 1107 is disposed on a side of the first dielectric body 1106 away from the first feeding layer 1105. Please refer to FIG. 23 and FIG. 24, the second feeding layer 1107 is provided with a plurality of second receiving grooves 11071, and the second receiving grooves 11071 penetrate the second feeding layer 1107. The second receiving grooves 11071 are disposed corresponding to the first receiving grooves 11051. Each second feeding portion 152 is disposed in a corresponding second receiving groove 11071. Thus, the first feeding portion 151 and the second feeding portion 152 are correspondingly arranged to form the feeding portion 15 for feeding current to the corresponding radiator 111. In this embodiment, the second feeding portion 152 is also a microstrip line that is substantially in the shape of an elongated strip. The second receiving groove 11071 is substantially circular. The first feeding portion 151 in the extension direction of the first feeding layer 1105 does not completely overlap with the corresponding second feeding portion 152 in the extension direction of the second feeding layer 1107. The first feeding portion 151 is used to generate a first polarized wave, and the second feeding portion 152 is used to generate a second polarized wave. For example, in the present embodiment, in the Z-axis projection direction of the antenna device 10, the first feeding portion 151 and the second feeding portion 152 are staggered at an angle.

In an embodiment of the present application, the one-to-one arrangement of the plurality of first feed portions 151 and the plurality of second feed portions 152 means that, in the projection along the Z-axis direction of the antenna device 10, the projection areas of the two structures are correspondingly arranged and at least partially overlap. In this way, the first feed portions 151 and the second feed portions 152 are correspondingly arranged, respectively, that is, in the projection along the Z-axis direction of the antenna device 10, the projection areas of the first feed portions 151 and the projection areas of the second feed portions 152 at least partially overlap with each other. For example, in the projection along the Z-axis direction of the antenna device 10, the projection area of the first feeding portion 151 completely overlaps with the projection area of the second feeding portion 152, or the projection area of the first feeding portion 151 partially overlaps with the projection area of the second feeding portion 152. In one embodiment of the present application, the projection area of the first feeding portion 151 partially overlaps with the projection area of the second feeding portion 152, but does not completely overlap.

In one embodiment of the present application, the plurality of coupling portions 16 are correspondingly arranged with the plurality of feeding portions 15. In this embodiment, the shape of the coupling portion 16 (i.e., the coupling slot 161 provided on the coupling layer 1103) and the projection shape of the feeding portion 15 in the Z-axis direction of the antenna device 10 may be the same or different, but must be long and narrow to achieve a coupling effect, such as an elliptical or long strip shape. In this way, the plurality of coupling portions 16 on the coupling layer 1103 can couple the electrical signal flowing through the feeding portion 15 to the radiator 111. In other embodiments, the coupling layer 1103 may also be replaced by a first coupling layer and a second coupling layer (not shown in the figure), and the first coupling layer is provided with a first coupling slot corresponding to the first feeding portion 151, and the second coupling layer is provided with a second coupling slot corresponding to the second feeding portion 152. In this way, the electrical signal flowing through the feeding portion 15 can also be coupled to the radiator 111 through the design of the first coupling layer and the second coupling layer.

Furthermore, in some embodiments, the multi-layer structure 10C further includes a third dielectric body 1108, a cavity layer 1109, a fourth dielectric body 1110, and a ground layer 1111.

The third dielectric body 1108 is disposed on a side of the second feeding layer 1107 away from the first dielectric body 1106.

The cavity layer 1109 is disposed on a side of the third dielectric body 1108 away from the second feeding layer 1107. The cavity layer 1109 is provided with a plurality of through cavities 11091 (see FIG. 25). The through cavities 11091 penetrate the cavity layer 1109, and the plurality of through cavities 11091 are correspondingly disposed with the plurality of feeding portions 15. The projection area of the through cavities 11091 obtained along the projection direction of the Z-axis of the antenna device 10 covers the projection area of the corresponding feeding portions 15 (i.e., the projection area of the first feeding portion 151 and the second feeding portion 152).

The fourth dielectric body 1110 is disposed on a side of the cavity layer 1109 away from the third dielectric body 1108.

The ground layer 1111 is disposed on a side of the fourth dielectric body 1110 away from the cavity layer 1109. The ground layer 1111 may be a metal coating disposed on a printed circuit board. The metal coating may be disposed on a side of the ground layer 1111 away from the fourth dielectric body 1110. In this embodiment, through holes 11031 are provided on the coupling layer 1103, the second dielectric body 1104, the first feeding layer 1105, the first dielectric body 1106, the second feeding layer 1107, the third dielectric body 1108, the cavity layer 1109, the fourth dielectric body 1110, and the grounding layer 1111 (only the through holes 11031 on the coupling layer 1103 are marked in FIG. 24, and the other layers are also provided with through holes, but are not marked), and the through holes 11031 of each layer are connected in sequence, and finally connected to the metal coating on the grounding layer 1111, so as to be grounded.

In each subunit a of the antenna device 10, the projection area of the radiator 111 in the Z-axis direction of the antenna device 10 completely covers the projection area of the coupling portion 16 in the Z-axis direction of the antenna device 10, so that the energy of the first feeding portion 151 and the second feeding portion 152 can be coupled to the radiator 111 as much as possible.

Furthermore, in the present application, the cavity layer 1109 is disposed between the second feeding layer 1107 and the ground layer 1111, and is used to increase the antenna height of the antenna device 10, thereby increasing the antenna gain of the antenna device 10. The second dielectric body 1104, the first dielectric body 1106, the third dielectric body 1108, and the fourth dielectric body 1110 are used to provide support to increase the antenna height of the antenna device 10, thereby further increasing the antenna gain. The second dielectric body 1104, the first dielectric body 1106, the third dielectric body 1108, and the fourth dielectric body 1110 may also be made of a material having a dielectric constant of about 2.4.

In some embodiments, the antenna device 10 further includes an radome 1116. The radome 1116 is disposed on a side of the first radiation layer 1101 away from the first dielectric layer 1102, and is used to protect the electronic components in the antenna device 10 from being exposed to the sun, rain, and dust, so as to improve the working stability of the antenna device 10. In this embodiment, the radome 1116 is also provided with a protective cavity 1117 corresponding to the radiator 111. For example, the protective cavity 1117 may be formed by a side of the radome 1116 close to the second radiator 1119 being recessed inward, and the protective cavity 1117 may be substantially cylindrical. In this way, the weight of the antenna device 10 may be reduced. In other embodiments, the antenna device 10 may not be provided with the radome 1116, that is, the radome 1116 may be provided according to actual needs.

In the antenna device 10, each two adjacent layers of structures may be connected by an adhesive. The present application does not limit the specific type of the adhesive.

Referring to FIG. 25, FIG. 25 illustrates a partial exploded schematic diagram of the multi-layer structure 10D (see FIG. 22) in an embodiment of the present application. In addition, FIG. 25 only shows a part of the number of layers to illustrate the technical concept of the structure of FIG. 22 of the present application, and the actual number of layers can be adjusted according to the needs.

The partial exploded schematic diagram of the multi-layer structure 10D (see FIG. 22) shown in FIG. 25 is substantially the same as the partial exploded schematic diagram of the multi-layer structure 10C (see FIG. 21) shown in FIG. 23, except that the multi-layer structure 10D further includes the second dielectric layer 1112, the second radiation layer 1113 and the second radiator 1119. The radome 1116 is disposed at a different position than that in the multi-layer structure 10C. Similarly, in the multi-layer structure 10D shown in FIG. 25, the radiator 111 disposed on the first radiation layer 1101 in the above other embodiments can be used as the first radiator 1118.

Specifically, the second dielectric layer 1112 is disposed on a side of the first radiation layer 1101 on which the first radiator 1118 is disposed. The second radiation layer 1113 is disposed on a side of the second dielectric layer 1112 away from the first radiation layer 1101. The second radiator 1119 is also disposed on a side of the second radiation layer 1113 away from the second dielectric layer 1112. The radome 1116 is disposed on one side of the second radiating layer 1113 where the second radiator 1119 is disposed. In other embodiments, the antenna device 10 may not be provided with the radome 1116, that is, the radome 1116 may be provided according to actual needs.

The projection area of the second radiator 1119 in the Z direction of the antenna device 10 covers the projection area of the first radiator 1118 in the Z direction of the antenna device 10. A cavity 1115 is formed on the second dielectric layer 1112. The first radiator 1118 is disposed in the cavity 1115.

Furthermore, in the antenna device 10, the first radiation layer 1101, the first dielectric layer 1102, the second radiation layer 1113, the second dielectric layer 1112, the second dielectric body 1104, the first dielectric body 1106, the third dielectric body 1108 and the fourth dielectric body 1110 may also have through holes at positions not corresponding to the first radiator 1118, so that the weight of the antenna device 10 can be further reduced.

Furthermore, each cavity 1115 penetrates the second dielectric layer 1112. The diameter of the cavity 1115 may be equal to the diameter of the corresponding protective cavity 1117, and the edge of the cavity 1115 is aligned with the edge of the protective cavity 1117. Each cavity 1115 is correspondingly arranged with the two radiators (i.e., the first radiator 1118 and the second radiator 1119) on both sides, respectively. Specifically, the line formed by the centers of the cavity 1115, the first radiator 1118, and the second radiator 1119 is parallel to the Z-axis of the antenna device 10. Moreover, the projection area of the second radiator 1119 in the Z-axis direction of the antenna device 10 is larger than the projection areas of the first radiator 1118 and the second radiator 1119 in the Z-axis direction of the antenna device 10. Thus, in this embodiment, the antenna height can be further increased by providing the first dielectric layer 1102 and the second dielectric layer 1112, thereby improving the antenna gain; and the second radiator 1119 is provided to cover the first radiator 1118, so that the energy coupled from the first radiator 1118 to the second radiator 1119 is more concentrated, thereby increasing the directivity of the energy beam of the antenna device 10.

The second dielectric layer 1112 can also be made of plastic or ceramic materials.

The present application does not limit the specific shapes of the first radiator 1118 and the second radiator 1119. For example, the shapes of the first radiator 1118 and the second radiator 1119 may be regular shapes such as a circle or a rectangle. In other embodiments, the shapes of the first radiator 111 and the second radiator 1119 may also be other irregular shapes, and the shapes of the first radiator 1118 and the second radiator 1119 may be the same or different. It is sufficient that the projection area of the first radiator 1118 in the Z-axis direction of the antenna device 10 can cover the projection area of the coupling portion 16 (see FIG. 25), and the projection area of the second radiator 1119 in the Z-axis direction of the antenna device 10 can cover the projection area of the first radiator 1118.

In summary, the antenna device 10 provided in the present application has a multi-layer structure (for example, multi-layer structures 10A, 10B, 10C and 10D), and multiple radiators 111 are connected to the beam forming module 13 through the plurality of phase couplers 12, and the phase coupler 121 is a 90-degree power divider, and the radiator 111 is a circularly polarized antenna. In this way, the phase coupler 121 can transmit two electrical signals with a phase difference of 90 degrees between the beam forming module 13 and the plurality of radiators 111, so that the radiator 111 is only connected to one radio frequency output interface and one radio frequency input interface in the beam forming module 13 through the phase coupler 121, so that the circular polarization effect can be stimulated when the antenna device 10 receives or transmits a wireless signal, which effectively reduces the quantity of beam forming modules in the antenna device 10, thereby reducing the design area and manufacturing cost of the antenna device 10, which is conducive to the miniaturization design of the product.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure, up to and including the full extent established by the broad general meaning of the terms used in the claims.

What is claimed is:

1. An antenna device comprising:
a plurality of radiators;
a plurality of first feeding portions;
a plurality of second feeding portions, each of the plurality of first feeding portions corresponded to each of the plurality of second feeding portions respectively;
a plurality of phase couplers, each of the plurality of phase couplers correspondingly connected to each of the plurality of first feeding portions and each of the plurality of second feeding portions, each of the plurality of phase couplers corresponded to each of the plurality of radiators; and
a plurality of beamforming units comprising a plurality of transmitting beamforming units and a plurality of receiving beamforming units;
wherein projection areas of each of the plurality of first feeding portions and each of the plurality of second feeding portions on the corresponding radiator at least partially overlap;
each of the phase couplers is respectively connected to one of the plurality of transmitting beamforming units and one of the plurality of receiving beamforming units.

2. The antenna device of claim 1, wherein each of the plurality of radiators serves as a receiving antenna at a first moment and as a transmitting antenna at a second moment.

3. The antenna device of claim 1, wherein the plurality of radiators comprise a plurality of first radiators and a plurality of second radiators, the plurality of first radiators and the plurality of second radiators are arranged in different planes, each of the plurality of first radiators and each of the plurality of second radiators correspond to each of the plurality of phase couplers respectively.

4. The antenna device of claim 1, further comprising a plurality of multiplexers arranged in different planes, the plurality of multiplexers configured to connect the plurality of transmitting beamforming units or the plurality of receiving beamforming units in parallel.

5. The antenna device of claim 4, wherein the plurality of multiplexers comprise a plurality of first multiplexers and a plurality of second multiplexers, the plurality of first multiplexers are connected between the plurality of transmitting beamforming units and a transmitting signal output point of the antenna device, the plurality of second multiplexers are connected between the plurality of receiving beamforming units and a receiving signal output point of the antenna device.

6. The antenna device of claim 1, further comprising a plurality of coupling slots, the plurality of coupling slots arranged correspondingly to the plurality of first feeding portions and the plurality of second feeding portions respectively.

7. The antenna device of claim 1, wherein each of the plurality of phase couplers is a 90-degree hybrid coupler.

8. The antenna device of claim 1, wherein each of the plurality of phase couplers comprises a transmitting port, a receiving port, a first signal terminal, and a second signal terminal, the transmitting port and the receiving port are on one side of the each of the plurality of phase couplers, the first signal terminal and the second signal terminal are on the other side of the each of the plurality of phase couplers.

9. The antenna device of claim 8, wherein a radiation pattern of the transmitting port is opposite to a radiation pattern of the receiving port.

10. The antenna device of claim 8, wherein each of the plurality of phase couplers is connected to one of the plurality of radiators through the first signal terminal and the second signal terminal, each of the plurality of phase coupler is connected to one of the plurality of transmitting beamforming unit through the transmitting port and one of the plurality of receiving beamforming unit through the receiving port.

11. An antenna device with multi-layer structure comprising:
at least one radiation layer arranged in at least one layer of the multi-layer structure, the at least one radiation layer comprising a plurality of radiators;
a first feeding layer and a second feeding layer arranged in different plane layers of the multi-layer structure, the first feeding layer provided with a plurality of first feeding portions, the second feeding layer provided with a plurality of second feeding portions, each of the plurality of first feeding portions corresponded to each of the plurality of second feeding portions respectively;
a plurality of phase couplers arranged in at least one layer of the multi-layer structure, each of the plurality of phase couplers correspondingly connected to each of the plurality of first feeding portions and each of the plurality of second feeding portions, each of the plurality of phase couplers corresponded to each of the plurality of radiators respectively; and
a plurality of beamforming units arranged on a surface layer of the multi-layer structure, the plurality of beamforming units comprising a plurality of transmitting beamforming units and a plurality of receiving beamforming units;
wherein a projection area of each of the plurality of first feeding portions on the corresponding radiator is partially overlap to a projection area of each of the plurality of second feeding portion on the corresponding radiator;
each of the plurality of phase couplers is respectively connected to one of the plurality of transmitting beamforming units and one of the plurality of receiving beamforming units.

12. The antenna device of claim 11, wherein each of the plurality of radiators serves as a receiving antenna at a first moment and as a transmitting antenna at a second moment.

13. The antenna device of claim 11, wherein the at least one radiation layer comprises a first radiation layer and a second radiation layer arranged in different planar layers of the multi-layer structure.

14. The antenna device of claim 13, wherein the plurality of radiators comprise a plurality of first radiators and a plurality of second radiators, the plurality of first radiators are arranged on the first radiation layer, the plurality of second radiators are arranged on the second radiation layer, each of the plurality of first radiators and each of the plurality of second radiators correspond to each of the plurality of phase couplers respectively.

15. The antenna device of claim 11, further comprising a plurality of multiplexers arranged in different plane layers of the multi-layer structure, the plurality of multiplexers configured to connect the plurality of transmitting beamforming units or the plurality of receiving beamforming units in parallel.

16. The antenna device of claim 15, wherein the plurality of multiplexers comprise a plurality of first multiplexers and a plurality of second multiplexers, the plurality of first multiplexers are connected between the plurality of transmitting beamforming units and a transmitting signal output point of the antenna device, the plurality of second multiplexers are connected between the plurality of receiving beamforming units and a receiving signal output point of the antenna device.

17. The antenna device of claim 11, further comprising a plurality of coupling slots arranged in a same plane layer of the multi-layer structure, the plurality of coupling slots arranged correspondingly to the plurality of first feeding portions and the plurality of second feeding portions respectively.

18. The antenna device of claim 11, wherein each of the plurality of phase couplers is a 90-degree hybrid coupler.

19. The antenna device of claim 11, wherein each of the plurality of phase couplers comprises a transmitting port, a receiving port, a first signal terminal, and a second signal terminal, the transmitting port and the receiving port are on one side of each of the plurality of the phase couplers, the first signal terminal and the second signal terminal are on the other side of each of the plurality of the phase couplers.

20. The antenna device of claim 11, wherein a radiation pattern of the transmitting port is opposite to a radiation pattern of the receiving port.
